(19) United States
(12) Patent Application Publication
(10) Pub. No.: US 2009/0252913 A1
(43) Pub. Date: Oct. 8, 2009

(54) Quick-change visual deception systems and methods

(75) Inventors: K. Dominic Cincotti, Fayetteville, NC (US); Trevor J. Kracker, Lumberton, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Military Wraps Research and Development, Inc.

(21) Appl. No.: 12/319,920

(22) Filed: Jan. 14, 2009

Related U.S. Application Data
(63) Continuation-in-part of application No. 12/221,540, filed on Aug. 4, 2008.
(60) Provisional application No. 61/011,016, filed on Jan. 14, 2008.

(51) Int. Cl. B32B 7/06; B32B 33/00; B32B 3/10; B32B 3/00; B05D 5/10

(52) U.S. Cl. 428/41.3; 428/41.9; 428/195.1; 428/189; 427/207.1; 156/289

(57) ABSTRACT

Quick change multi-layered deception systems and methods for visually disguising a physical item is provided. One or more other vinyl adhesive layers are applied successively over a surface of a physical item. Each of the one or more other vinyl adhesive layers has a different pattern from the layer preceding it. A quick removal preparation can be applied between each of the one or more vinyl adhesive layers, whereby each of the one or more vinyl adhesive layers is configured to be easily removable from the preceding vinyl adhesive layer or surface of the physical item.

### RELATED APPLICATIONS

The presently disclosed subject matter claims the benefit of U.S. Provisional Patent Application Ser. No. 61/011,016, filed Jan. 14, 2008; the disclosure of which is incorporated herein by reference in its entirety. Further, this application is a continuation-in-part patent application which claims the benefit of the filing date of U.S. patent application Ser. No. 12/221,540, filed Aug. 4, 2008, the disclosure of which is incorporated herein by reference in its entirety.

### TECHNICAL FIELD

Quick change multi-layered deception systems and methods for visually disguising a physical item are provided. In particular, visual disguise and deception systems and methods are provided whereby the rapid change of appearance of a physical item is achieved through a process of designing, printing, and applying in successive order, multiple vinyl adhesive layers that differ in color and/or imagery, onto the physical item, for example, a vehicle, with each layer being swiftly removable to reveal the next layer disposed beneath it.

### BACKGROUND

Adaptability and simulation of change are highly sought after capabilities in the art of camouflage, concealment and deception. Changing the appearance of a vehicle for surveillance purposes can be beneficial in covert and surveillance operations. Previously in the field, these capabilities would have been attempted only through a paint process, for objects such as vehicles. Such painting is time consuming and costly. Thus, it is generally not feasible to change the appearance of the surveillance vehicle during covert and surveillance operations. It can generally only be done after each operation.

Similarly, quick change capabilities of camouflage on military vehicles can be desirable. For example, if a force is to be moved from a desert terrain to a jungle terrain, the camouflage on the vehicles need to be changed. However, these changes are generally made by repainting the vehicles. Again, this repainting is time-consuming and costly.

For example, on Aug. 6, 1990, elements of a Marine Expeditionary Force began preparations for deployment to Saudi Arabia. During mission analysis, the determination was made to change the camouflage color of the equipment from green to desert tan. Consultation with the depot-level maintenance experts revealed that the depots could not handle the enormous volume of painting required. Additionally, the materials required for the painting task were not available in sufficient quantities.

As various staffs worked diligently to find a suitable alternative to the green camouflage paint scheme, the evidence indicated that this was a service-wide problem. Specifically, the problem is that no suitable method exists to rapidly change the camouflage color on military equipment. The cause of the problem is exacerbated by the requirement to use chemical agent resistant coating (“CARC”). The solution to this problem requires the Department of Defense to discontinue the use of CARC paint and to allow local facilities to paint their equipment when operational necessity dictates.

While it appears that CARC is the ideal paint for camouflage and chemical protection, it is important to realize this relationship directly contributes to the problem. Several disadvantages are obvious when attempting to rapidly change color. CARC paint is considered environmentally hazardous, and its application requires environmental Protection Agency (“EPA”) approved safety equipment and facilities. The EPA regulations restrict the use of CARC to one quart per site per day. Only approved facilities, such as depot-level maintenance facilities can dispense CARC in volume. This restriction on volume painting is attributed to the amount of volatile organic compounds released into the atmosphere when spraying. Further, CARC is expensive and has a limited shelf life. In fact, CARC is approximately four-times more expensive than a low emission alkyd or polyurethane paint. Additionally, the camouflage created from paints is not that effective. With the advent of electronic optical devices, such painting schemes are even less effective.

Thus, a need exists for systems and related methods for quick change visual deception for visually disguising objects used in covert and surveillance operations and military operations.

### SUMMARY

It is an object of the presently disclosed subject matter to provide systems and related methods for quick change visual deception for visually disguising a physical item.

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

The patent or application file contains at least one drawing executed in color. Copies of this patent or application with color drawing(s) will be provided by the Patent and Trademark Office upon request and payment of necessary fee.

A full and enabling disclosure of the present subject matter including the best mode thereof to one of ordinary skill in the art is set forth more particularly in the remainder of the specification, including reference to the accompanying figures, in which:

FIGS. 1A-1D illustrate an embodiment of quick change multi-layered deception system for visually disguising an object according to the present subject matter;

FIGS. 2A-2C illustrate an embodiment of quick change multi-layered deception system for visually disguising an object according to the present subject matter;

FIGS. 3A-3G illustrate an embodiment of quick change multi-layered deception system and related method for visually disguising an object according to the present subject matter;

FIG. 4 illustrates an embodiment of a physical item having an embodiment of a camouflage pattern or arrangement attached thereto according to the present subject matter;

FIG. 5 illustrates an embodiment of panels having a camouflage pattern printed thereon that can be attached to a physical item according to the present subject matter;

FIGS. 6A and 6B illustrate embodiments of a camouflage pattern or arrangement according to the present subject matter;

FIGS. 7A and 7B illustrate other embodiments of a camouflage pattern or arrangement according to the present subject matter;

FIG. 8 illustrates a perspective view of a physical item having embodiments of a camouflage pattern or arrangement placed thereon according to the present subject matter;

FIGS. 9-15 illustrate steps for creating embodiments of a camouflage pattern or arrangement according to the present subject matter;

FIGS. 16-25 illustrate steps for creating other embodiments of a camouflage pattern or arrangement according to the present subject matter;

FIGS. 26-29 illustrate steps for an embodiment of a mock-up process for embodiments of a camouflage pattern or arrangement according to the present subject matter; and

FIG. 30 illustrates a further embodiment of a camouflage pattern or arrangement according to the present subject matter.

### DETAILED DESCRIPTION

Reference will now be made in detail to the description of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the present subject matter cover such modifications and variations.

“Site-specific” as used herein means a specific local terrain, nautical position, or airspace where a physical item will be located or operating, or the environmental characteristics which would be found in the intended operating environment of the physical item.

“Pattern” as used herein means any color and/or imagery, including, but not limited to camouflage patterns, repeating and non-repeating designs, deceptive designs, such as imagery that give the perception that a vehicle is an ambulance, taxi, police vehicle, or the like, and outward physical characteristics of a physical item such as rust, dents scratches, or the like, printed to a vinyl adhesive layer.

“Disruptive pattern” as used herein means a pattern of shapes that when configured on an image will cause visual confusion.

“Distortions,” “distorting,” and variations thereof as used herein means the changing of at least a portion of an image by manipulating the focal lengths within those portions of the image, adding to a first image a portion of the image or a portion of different image that has a different focal length than the first image, or adding shapes of color that change the appearance of the image. Focal lengths can include improper focal lengths that cause at least a portion of the image to appear to be out of focus.

“Focal lengths” as used herein means the distance at which an image will come into visual focus either by a human observer or through electronic, electromechanical and/or optical methods and devices. Focal lengths can include improper focal lengths that cause at least a portion of the image to appear to be out of focus.

“Image-editing program” as used herein means a computer program used to edit or change an image. Examples include Adobe PHOTOSHOP®, PAINT.NET® and PICASA®.

“Image” as used herein means the optical counterpart of an object or environment produced by graphical drawing by a person, a device (such as a computer) or a combination thereof. The optical counterpart of the object can also be produced by an optical device electromechanical device or electronic device. As used herein, “image” can be used to refer to a whole image, for example, a photographic image as taken by a photographic device, or a portion thereof.

Visual disguise and deception systems and methods are described herein whereby the rapid change of appearance of an object is achieved through a process of designing, printing, and applying in successive order, multiple vinyl adhesive layers that differ in color and/or imagery, onto a physical item. Such physical items can include, but are not limited to any and all types of vehicles (land, air and sea, and rail/manned & unmanned), aircraft, watercraft, structures, buildings, pipes and piping, equipment, weapons, hardware, and other items used for military or other purposes where a covering can enhance its effective use or where the need for camouflage concealment or deception exists.

Each vinyl adhesive layer is applied in such a way that permits the subsequent expeditious removal of each of the multiple outer vinyl layers separately. With the removal of each layer, a different inner vinyl layer with colors and/ imagery differing from the previous layer is revealed. These resulting actions comprise a quick and effective system for changing the visual color or visual characteristics of a physical item such as a vehicle. Additionally, these visual disguise and deception systems and methods can inhibit the ability to recognize, identify and recall the vehicle or other physical item as a means of disguise and deception.

The visual disguise and deception systems and methods can be used for disguise or deception purposes in a covert or surveillance role, or setting. To accomplish this type of use, the multiple laminated vinyl adhesive layers can be applied on top of each other with each layer having a different color, imagery, or appearance than the preceding layer. Each top or outermost layer can be rapidly removed by peeling away an outer layer of printed vinyl adhesive to reveal the next vinyl adhesive layer. This next layer can be different in color, imagery or appearance than the removed outer adhesive vinyl layer changing drastically the color, outer condition, appearance, or perceived identity of the physical item, or vehicle, upon which the system is employed. Thereby, visual disguise and deception systems and methods can provide the means for deceiving the viewer, or allowing for continued operation in a covert setting.

The visual disguise and deception systems and methods can also be used in a military setting to provide a quick-change mechanism for changing military camouflage patterns from one camouflage pattern to another. To accomplish this type of use, the multiple laminated vinyl adhesive layers can be applied on top of each other with each layer having a different color, imagery, or appearance than the preceding layer. A process is described herein for developing a camouflage pattern. The camouflage pattern can be transferred to a vinyl adhesive layer for covering physical items.

The camouflage patterns and processes can use photo-digital processes to create the camouflage patterns. The variations of the processes described herein are distinguishable from any previously identified photo-digital camouflages processes in numerous ways. For example, these processes seek to disrupt the normal environment of the site-specific photographs to disrupt vision rather than attempting to create a camouflage pattern to match the photograph or appear to be part of the environment displayed on the photograph. Also, the various camouflage patterns described herein create distinct camouflage patterns for different or multiple visual angles or perspectives of the same object in order to maximize stealth or concealment from each angle. Rather than attempting to create a camouflage pattern that is realistic or similar to what is displayed in a photograph, the camouflage patterns described herein are attempting to distort the image to disrupt vision thereby making the camouflage pattern more effective.

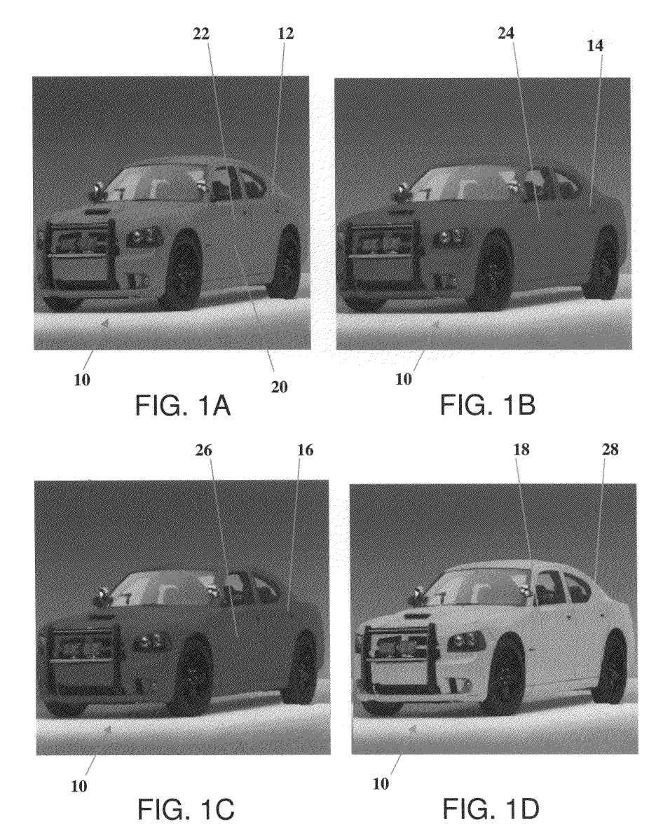

FIGS. 1A-1D illustrate an example of a vehicle, generally designated 10. In FIG. 1A, the vehicle 10 is shown with its base paint coating 12. For example, the base paint coating 12 can be a paint job applied to the vehicle at the factory. Such a paint coating 12 can be generally permanent and is not easily removed. The paint coating 12 can be different layers of paints and sealants. The paint coating 12 can provide a base pattern 22 in the form of a color. In some embodiments, the paint coating 12 can be a pattern that is an image or design. The design can be repeating. The paint coating 12 can provide a surface 20 of the vehicle 10 on which a first vinyl adhesive layer 14 can be applied as shown in FIG. 1B.

The first vinyl adhesive layer 14 can be applied over the paint coating 12 of the vehicle 10 so that the first vinyl adhesive layer 14 is secure to the vehicle 10, but can be quickly easily removed by a user when the user decides it is the appropriate time to remove the first adhesive layer 14. The first vinyl adhesive layer 14 can be applied to the surface 20 of the vehicle 10 in a manner described in more detail below. For example, each vinyl adhesive layer 14, 16, 18 can comprise a series of overlapping panels. As shown in FIG. 1B, the first adhesive layer 14 can have a first pattern 24 in the form of a color that is different from the color of the pattern 22 of the paint coating 12.

As shown in FIG. 1C, a second vinyl adhesive layer 16 can be applied over the first vinyl adhesive layer 14 so that the second vinyl adhesive layer 16 is secure to the vehicle 10, but can be quickly easily removed by a user when the user decides it is the appropriate time to remove the second vinyl adhesive layer 16. The second vinyl adhesive layer 16 can have a second pattern 26 that is different from the first pattern 24 of the first adhesive layer 14 and different from the base pattern 22 of the paint coating 12. The second pattern 26 can be in the form of a color. As shown in FIG. 1C, the color of the second pattern 26 can be different from the color of the first pattern 24 of the first adhesive layer 14 and the color of the base pattern 22 of the paint coating 12.

As shown in FIG. 1D, a third vinyl adhesive layer 18 can be applied over the second vinyl adhesive layer 16 so that the third vinyl adhesive layer 18 is secure to the vehicle 10, but can be quickly and easily removed by a user when the user decides it is the appropriate time to remove the third vinyl adhesive layer 18. The third vinyl adhesive layer 18 can have a third pattern 28 that is different from the second pattern 26 of the second adhesive layer 16, the first pattern 24 of the first adhesive layer 14 and the base pattern 22 of the paint coating 12. For example, the third pattern 28 can be in the form of a color that is different from the color of the second pattern 26 of the second adhesive layer 16, the color of the first pattern 24 of the first adhesive layer 14 and the color of the base pattern 22 of the paint coating 12.

Each of the three vinyl layers 14, 16, 18 covers the entire body portion of the vehicle 10. While the windows aren't covered, in the embodiment shown in FIGS. 1A-1D, window perforations as described below can be used with a layer. In this manner, each of the three vinyl layers 14, 16, 18, when that layer serves as the outermost layer, gives the impression of being the true outward embodiment of the vehicle 10, i.e., its true color, imagery, and condition.

After the three vinyl adhesive layers 14, 16, 18 are successively applied, the vehicle 10 can be easily stripped of the respective top layer for a quick-change intended for disguise or deception purposes as in a covert or surveillance role, or setting. The subsequent expeditious removal of each of the multiple outer vinyl layers separately reveals a different inner vinyl layer with colors or characteristics differing from the previous layer. For example, the third vinyl adhesive layer 18 is the top layer shown in FIGS. 1A-1D. When deemed appropriate, the third vinyl adhesive layer 18 shown in FIG. 1D can be removed, for example, by peeling or stripping it away to reveal the second vinyl adhesive layer 16 shown in FIG. 1C. Then, when appropriate, the user can remove the second vinyl adhesive layer 16 to reveal the first vinyl adhesive layer 14 as shown in FIG. 1B. Finally, if needed, the user can remove the first vinyl adhesive layer 14 to reveal the base paint coating 12 as shown in FIG. 1A.

In this manner the color of the vehicle 10 can change in a matter of minutes from one color in one pattern to a different color in another pattern. Such changing of the color of the vehicle 10 can occur three different times providing four different colors of the vehicle 10 in the embodiment shown in FIGS. 1A-1D. For example, third pattern 28 can be changed to a second pattern 26. The second pattern 26 can be changed to a first pattern 24. Finally, the first pattern 24 can be changed to the base pattern 22 of the paint coating 12.

To facilitate removal of each respective outermost vinyl adhesive layer 14, 16, 18, a quick removal preparation can be applied between the layers 14, 16, 18 and/or each vinyl adhesive layer can include a peel tab. The quick removal preparation can be a petroleum distillate preparation. The petroleum distillate preparation can include a friction reducing additive. For example, the additive can be a polymer having a low coefficient of friction. For instance, the polymer can be at least one of polytetrafluoroethylene, perfluoroalkoxy, and fluorinated ethylene propylene.

The quick removal preparation can be applied to a layer 14 and 16 before application of a subsequent respective layer 16, 18. Once a vinyl adhesive layer 14, 16 is applied on a physical item such as vehicle 10, the preparation can be applied across that entire vinyl adhesive layer 14, 16 for the application of the next vinyl adhesive layer 16, 18 thereon respectively. The preparation can be applied liberally with a cloth and the excess later wiped clear before application of the next vinyl adhesive layer. Alternatively, alternating areas of the surface on which the preparation is applied can be left free of the preparation to permit adhesion before adding subsequent layers. These alternating areas can create an application pattern for applying the quick removal preparation to optimize both the securing of the vinyl adhesive layer to the vehicle 10 and the facilitating of the removal of the vinyl adhesive layer at the appropriate time. The quick removal preparation permits the next layer applied upon an installed layer or a surface of the object, such as vehicle 10, to be secured thereto for multi-layering, while permitting easy peeling away of that top next layer from the installed layer or surface of the physical item. The use of the preparation can permit five or more vinyl adhesive layers to be removable secured to a physical item such as vehicle 10.

For example, with the petroleum distillate preparation, it can be applied with a cloth or as a spray. Once applied, the user can wait for the petroleum distillate preparation to at least partially dry. The petroleum distillate preparation will begin to haze as it dries. At this point, the user can take a clean cloth and remove the excess or the dried portion of the petroleum distillate preparation. The next vinyl adhesive layer can then be applied to the vehicle.

As stated above, while the preparation is normally applied over the entire layer, the quick removal preparation can also be applied in a pattern of alternating areas. For example, the quick removal preparation can be applied in a checkerboard pattern of about 6 to about 12 inch alternating squares with each square alternating with a square containing no quick removal preparation can be applied. Other patterns can also be used that promote easy peeling away of that outermost layer from the installed layer or surface of the physical item.

To further facilitate ease of removal of each layer, a peel tab can be created that can serve as an apparatus for peeling away an outer vinyl layer to reveal a differing inner layer in an expeditious manner. The peel tab can be used only on the top outermost layer. Alternatively, the peel tab can be used on other layers. In embodiments where multiple vinyl adhesive layers include peel tabs, the peel tabs for each layer can be located in a different location from the preceding layer. For example, the a peel tab can be located in an upright right-hand corner of a panel of a first vinyl adhesive layer, while the peel tab for a panel of a second vinyl adhesive layer applied over the panel of the first vinyl adhesive layer can be located at the bottom left-hand corner.

The peel tab can serve as the demarcation for the location to begin the peeling of the layer. The peel tab can be created by the discrete folding over of a corner of the outermost border section thereby blocking the adhesive and creating a start point that is barely perceptible upon inspection, for the quick peeling off of a layer. For example, the peel tab may be about 0.25 inches or less in depth as measured from the outermost tip of the peel tab to the base where the panel of the vinyl adhesive layer is secured to the physical item, such that is not perceptible from about 10 feet away from the vehicle. No quick removal preparation needs to be applied under the peel tab.

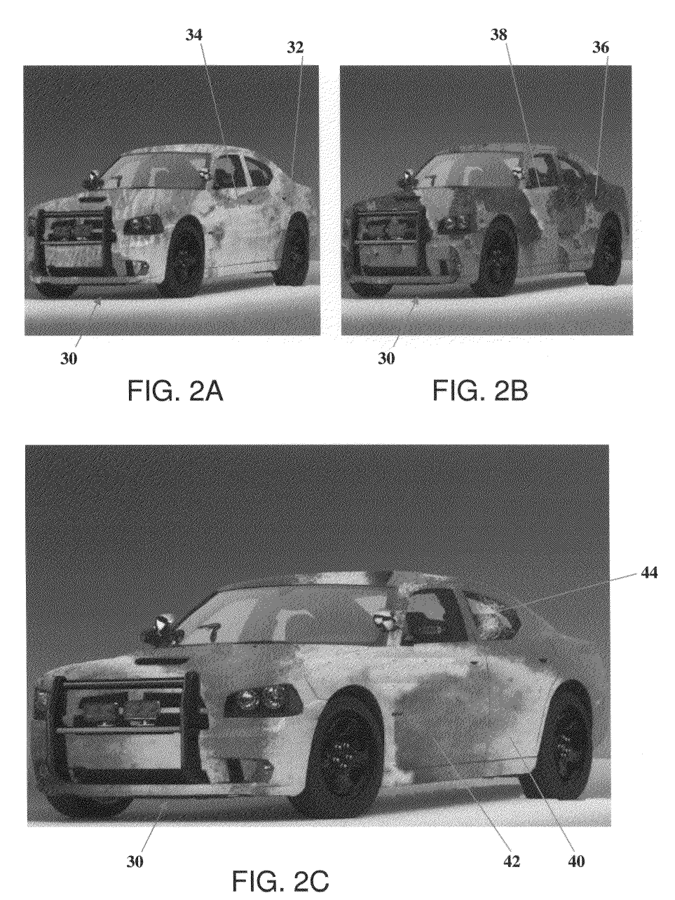

FIGS. 2A-2C illustrate an example of a similar vehicle, generally designated 30, as the vehicle 10 illustrated in FIGS. 1A-1D. A first vinyl adhesive layer 32 can be applied onto an outer surface of the vehicle 30. The first vinyl adhesive layer 32 can include a first pattern 34 in the form of imagery such as a first camouflage pattern. A second vinyl adhesive layer 36 can be applied over the first vinyl adhesive layer 32 so that the second vinyl adhesive layer 36 is secured to the vehicle 30. The second vinyl adhesive layer 36 can include a second pattern 38 in the form of imagery such as a second camouflage pattern that is different from the first pattern 34 of the first vinyl adhesive layer 32. A third vinyl adhesive layer 40 can be applied over the second vinyl adhesive layer 36 so that the third vinyl adhesive layer 40 is secure to the vehicle 30. The third vinyl adhesive layer 40 can include a third pattern 42 in the form of imagery such as a third camouflage pattern that is different from the first pattern 34 of the first vinyl adhesive layer 32 and the second pattern 38 of the second vinyl adhesive layer 36. Each of the vinyl adhesive layers 32, 36, and 40 can be quickly easily removed by a user when the user decides it is the appropriate time to remove the first vinyl adhesive layer 32 as described above. The vinyl adhesive layer can also include patterns on panels that can change the outward characteristics. For example, a panel 44 can be secured over the window to make it appear that the window is broken. Other such characteristics can include the appearance of rust, dents, scratches, or the like.

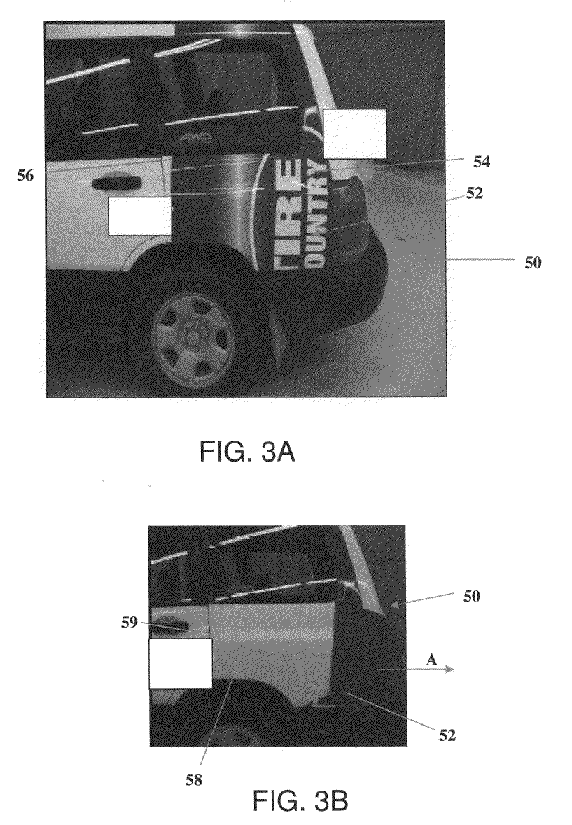

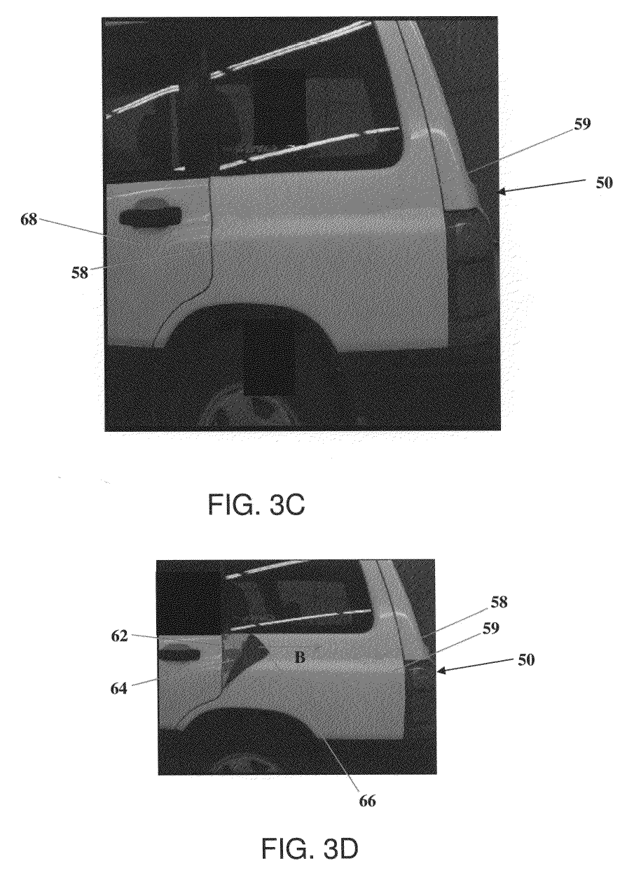

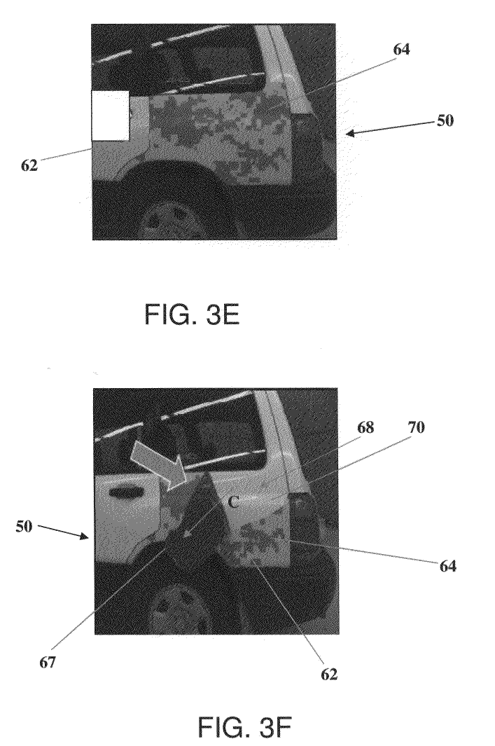

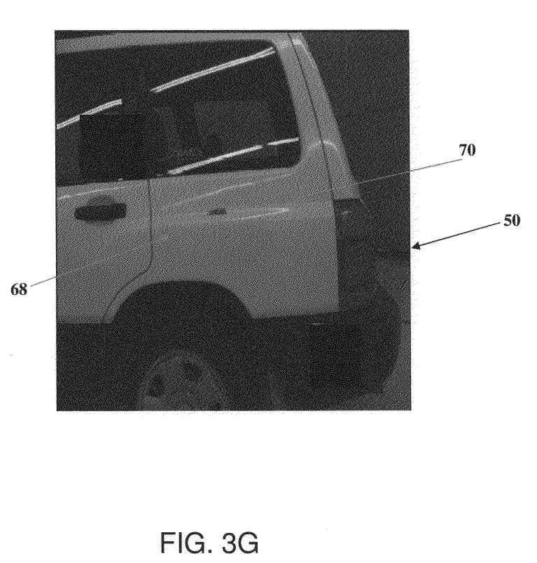

FIGS. 3A-3G illustrate a system and method for the quick removal of different adhesive vinyl layers from an object, in the form of a vehicle, generally designated 50. To provide background of the configuration of the system, a description of the vehicle 50 as it is in FIG. 3A is provided. While in practice the entire outer body of the vehicle 50 can be covered in different panels of different layers, only a single panel of each different layer is illustrated for clarity. The vehicle 50 has a panel of a first adhesive layer 62 removably applied to a portion of a paint coating 68 of the vehicle 50 (see FIGS. 3E-3G). A panel of a second vinyl adhesive layer 58 is removably applied to the panel of the first adhesive layer 62 (see FIGS. 3C-3D) and a panel of a third, outermost vinyl adhesive layer 52 is removably applied to the panel of the second adhesive layer 58 (see FIGS. 3A-3B).

As shown in FIG. 3A, the panel of the third and outermost vinyl adhesive layer 52 can have a third pattern 54. As shown in FIG. 3A, the third pattern 54 can be a visual disguise such as visual imagery that contains the marks of a rescue/emergency vehicle, a taxi, a service vehicle, or the like. Further, the third pattern can be a camouflage pattern, a repeating or non-repeating design, or just a specific color. The pattern can also portray outward characteristic of the vehicle 50 such as rust, dents, scratches, or the like. The panel of the third and outermost vinyl adhesive layer 52 can include a peel tab 56 that is barely perceptible upon inspection, for the quick peeling off of the layer. The peel tab 56 can be at a corner of the panel or some other location.

As shown in FIG. 3B, using the peel tab 56, the panel of the third vinyl adhesive layer 52 can be pulled in a direction A to remove the panel of the third vinyl adhesive layer 52 from a panel of the second vinyl adhesive layer 58. In this manner, the third vinyl adhesive layer 52 can be peeled away from the second vinyl adhesive layer 58 in a short period of time. For example, the third vinyl adhesive layer 52 can be peeled away from the second vinyl adhesive layer 58 in a matter of seconds, for instance between about 5 seconds to about 45 seconds. However, depending on how well the third vinyl adhesive layer 52 is adhered to the second vinyl adhesive layer 58 and the strength and thickness of the third vinyl adhesive layer 52, the peeling can take longer.

As shown in FIG. 3C, the panel of the second vinyl adhesive layer 58 is now the outermost panel on the portion of the vehicle 50 shown. The second vinyl adhesive layer 58 can have a second pattern 59. As shown in FIG. 3C, the second pattern 59 can be a panel of a consistent color. For example, the second pattern 59 can be substantially similar to or match the color of the original paint coating 68 of the vehicle 50 as shown on a door of the vehicle 50 in FIG. 3C. Alternatively, the second pattern 59 can be a visual disguise such as visual imagery that contains the marks of a rescue/emergency vehicle, a taxi, a service vehicle, or the like, or a camouflage pattern, a repeating or non-repeating design, or the like.

The panel of the second vinyl adhesive layer 58 can include a peel tab 60 located at a corner of the panel as shown in FIG. 3D. The peel tab 60 can be barely perceptible upon inspection, but can be large enough for the quick peeling off of the layer. As shown in FIG. 3D, using the peel tab 60, the panel of the second vinyl adhesive layer 58 can be pulled in a direction B to remove the panel of the second vinyl adhesive layer 58 from the first vinyl adhesive layer 62. In this manner, the second vinyl adhesive layer 58 can be peeled away from the first vinyl adhesive layer 62 in a short period of time, similar to the time needed to remove the third vinyl adhesive layer 52.

At this point, the panel of the first vinyl adhesive layer 62 is now the outermost panel on the portion of the vehicle 50 as shown in FIG. 3E. The first vinyl adhesive layer 62 can have a first pattern 64. As shown in FIG. 3E, the first pattern 64 can be a camouflage pattern. Alternatively, the first pattern 64 can be a visual disguise such as visual imagery that contains the marks of a rescue/emergency vehicle, a taxi, a service vehicle, or the like, or a specific color, a repeating or non-repeating design, or the like.

The panel of the first vinyl adhesive layer 62 can include a peel tab 66 located at a corner of the panel as shown in FIG. 3F. The peel tab 66 can be a different location than the peel tab 60 of the second vinyl adhesive layer 58 or the peel tab 56 of the third vinyl adhesive layer 52. As shown in FIG. 3D, using the peel tab 66, the panel of the first vinyl adhesive layer 62 can be pulled in a direction C to remove the panel of the first vinyl adhesive layer 62 from the base paint coating 68 of the vehicle 68. As can be seen from the location of the peel tabs and the directions of the peeling of the layers, each location of the peel tabs and the direction of peeling can be different from the others adjacent to it to minimize the opportunity of accidentally removing and extra layer when trying to remove a single layer. Different locations of the peel tabs can also decrease the perceptibility of such peel tabs.

As shown in FIGS. 3F and 3G, the paint coating 68 of the vehicle 50 is exposed. The paint coating 68 can be the paint coating provided at the factory or can be a customized coating applied after manufacture. The paint coating 68 can include a base pattern 70. As shown in FIG. 3C, the base pattern 70 can be a consistent color. Alternatively, the base pattern can contain other imagery.

The creation of the vinyl adhesive layers will now be described in more detail. When creating the vinyl adhesive layers, a pattern can be created on an image-editing program for printing on the vinyl layer. Once the desired pattern is confirmed as described above, a proof can be printed at this stage to check and see if the appropriate color, clarity, and depth are still being achieved for the layers.

Next, using an image-editing program, the image of the pattern to be applied to each vinyl adhesive layer can be divided into the sections called panels hereinabove. After printing, these panels will fit together overlapping one another when placed on the physical item. No registry lines are necessary. The overlapping of the panels improves seal, adhesion, and installation procedures. The sizes of the panels can depend on the size of the physical item to be covered and are only constrained by the cost effectiveness of the selected size, manageability of the installation process, and the printer capabilities. For example, the panels can range from a few square inches to lengths and widths of 100 inches or more.

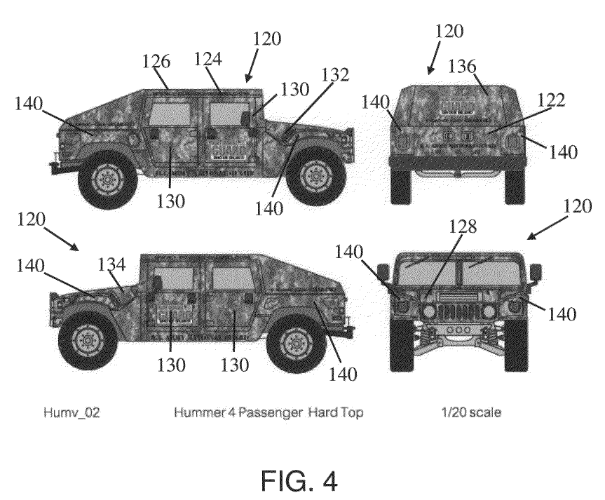

The panel process and application is explained using a specific example of a typical U.S. Military 1025 HUMVEE# 120 shown in FIG. 4. However, the same general process can be used with other physical items. The design is divided into the following corresponding panels which in FIG. 4 have been printed to a substrate such as a polyvinyl chloride (PVC) film and already applied to the HUMVEE# 120: a tailgate panel 122, a first roof panel 124 (partially shown), a second roof panel 126 (partially shown), a boot panel 128, door panels 130, a center hood panel (not shown), left and right hood panels 132, 134, (partially shown), a back panel 136, and fender/frame panels 140.

If the three items of color, clarity, and depth are achieved, then the panel sections are saved and sent to the printer to begin the “rip” process of transferring the panel images to the printer and the printer's software. Before the rip process is to begin, another proof can be printed to make sure that nothing has moved or been dropped from the file. Once this proof is checked, a test print process of printing an actual panel or a portion of an actual panel on a layer can be done to make sure the colors match between the pattern on the screen of the computer and the pattern printed on the panel of the layer.

If there is a match, the production operator then begins to print the necessary panels for the HUMVEE# 120. In the case of the HUMVEE# 120, there are 15 panels that are printed in our process. Each panel runs different in size. The sizes provided below are provided as only examples and the number and size of the panels may vary based on the criteria outlined above. In particular, the sizes of the panels can depend on the size of the physical item to be covered and are only constrained by the cost effectiveness of the selected size, manageability of the installation process, and the printer capabilities. The selected sizes can assist with the installation process. The selected sizes can help with manageability and control of the product for the installation crews during the installation process. The selected sizes can promote versatility as some of the installations are done outdoors and some are done indoors. Wind and the elements are a factor in the installation process.

For the example HUMVEE™ 120, 15 panels can be printed in the following sizes:

1. 1—21″×87″ tailgate panel;

2. 1—52″×74″ first roof panel;

3. 1—52″×74″ second roof panel;

4. 1—60″×53″ boot panel;

5. 4—95″×53″ door panels;

6. 1—54″×70″ center hood panel;

7. 1—36″×70″ left hood panel;

8. 1—36″×70″ right hood panel;

9. 2—53×80 back panel;

10. 1—53″×80″ first fender/frame panel; and

11. 1—53″×80″ second fender/frame panel.

The pattern can be printed on a vinyl adhesive layer. An example of a vinyl adhesive layer that can be used is a polyvinyl chloride (“PVC”) film. For such a film, the conditions in the printing area are preferably controlled. For example, the room temperature and relative humidity can be between about 60° F. to about 90° F. and the relative humidity can be between about 50% to about 90% RH. For instance, the temperature and relative humidity can be about 73° F. (23° C.) and 50% RH when using as a substrate a 2.7 mil gloss white, polymeric stabilized, soft calendared PVC film designed for receiving digital ink jet printers. The ink used can be printing inks such as digital printing inks. Different inks can be used to ascertain different properties in the final product. The substrate used can be coated on one side with a permanent, opaque, acrylic, pressure sensitive adhesive with air egress technology and supplied with a 80# poly coated liner that is used as a release liner to protect the adhesive until time for application. Below is a list of physical properties of an example acrylic adhesive that can be applied to a substrate such as the PVC film described above.

TABLE 1
Properties of an Example Pressure Adhesive

| | | Test Method |
|---|---|---|
| | | (Federal Test |
| Physical Properties | Typical Values | Methods used) |
| Peel Adhesion, lb./in. | about 3.2-about 4.6 | FTM - 1 |
| (N/25 mm) | (about 14-20) | |
| 180 degrees on glass - | | |
| 24 hr | | |
| Quick Tack on Glass | about 3.4-about 4.8 | FTM - 9 |
| lb./in. (N/25 mm) | (about 15-about 21) | |
| Dimensional Stability, (%) | Maximum of about 0.5 | FTM - 14 |
| 10″ by 10″ sample | | |
| bonded to Aluminum | | |
| Normal Application | Above about 50° F. | |
| Temperature and | (about +10° C.) | |
| Temperature Ranges for | About −40° F. to about | |
| Minimum Application | 194° F. (about −40° C. | |
| | to about 90° C.) | |

Once the material is printed, it is laid on a drying table and left to “gas” or “dry” for a period of about 72 hours to ensure that the ink is dry. Once the layer has gone through the 72 hour period and depending on the end use of the layer, then it can be laminated in a lamination process to provide an overcoating. For example, for a layer of a PVC film to be used to cover a vehicle, the PVC film can be laminated. Laminating a layer like PVC film can add strength and protection to the printed image. For example, a laminate when bonded with the PVC film can provide protection to a vehicle on which it is applied (and any individuals inside) against chemical and biological agents and it can help protect the vehicle from corrosive agents as well. It can also be used to add gloss or a reflection control layer.

The layer used in such a lamination process can be a highly conformable cast film, such as a PVC film, that can range in thickness from about 0.5 mm to about 10 mm. For example, highly conformable cast film having thickness of about 1.5 mm can be used. A cast vinyl laminate can have a built-in ultraviolet protection, be optically clear, and have a low gloss or no-gloss (flat) finish or matte. The laminate can include a permanent adhesive, such as an acrylic adhesive.

The printed layer and the laminate can be run through a lamination process where the adhesive side of the laminate faces the printed side of the substrate. The laminate and layer can then pass through pressurized heated or unheated rollers to secure the laminate to the layer. The laminate can be usable in temperatures from about 50° F. to about 225° F. Thus, the laminate can be applied to the layer in hot and cold applications. In the PVC film example, the layer can be left to cool after the material is laminated at about 120° F.

In another example, a 1.5-mil clear matte or a 1.5-mil clear gloss, which are highly conformable cast PVC films, can be chosen as the laminate. The over-laminate film is coated on one side with a clear permanent, acrylic pressure sensitive adhesive and supplied with a 1.2 mil polyester release liner. Upon application, the release liner can be removed. The printed substrate and the laminate can be aligned so that the adhesive side of the laminate faces the printed side of the substrate. The laminate and substrate can then pass through pressurized rollers to secure the laminate to the substrate. UV protection can incorporated into the over-laminating film to help extend the life of the graphic by resisting color fade caused by ultraviolet light.

Suitable layers with the printed patterns described above that have a protective overcoating laminated thereto can provide excellent quick changeability for the user to change the outward appearance of the physical item to be covered. An installation process for securing the layer to a physical item is described in more detail below.

For an embodiment of a layer with the pattern thereon that is to be attached to a physical item, an installation process can be used to facilitate proper attachment to the wherein the substrate is the PVC film example given above, installers now prepare the vehicle for the installation process. The installation process can be done in various ways. An example process is provided below. The example installation process contains six general steps. The steps of the example installation process are provided below.

### Example of Installation Method

### Step 1. Check the Material

1. Look at the template; it should be confirmed that the overlapping panels to be installed are the correct panels for the physical item selected for installation.

2. Confirm that all overlapping panels are available.

3. Do an initial “tape up” to ensure proper fit & alignment placing emphasis on not losing any text or design features.

### Step 2. Remove Obstacles

1. Determine if accessories from the physical item having a vinyl adhesive layer placed therein need to be removed to facilitate attachment of the overlapping panels to the physical item. Examples of accessories for a vehicle can include the following:
A. Mirrors;
B. Antennas;
C. Door handles;
D. Rubber window tracks;
E. Lamp Assemblies;
F. Emblems (ask customer, some may not want off); and
G. Any old graphics (pin stripping & vinyl decals, etc).

### Step 3. Clean Vehicle Thoroughly

1. Use a good wax & grease remover (wet rag & dry rag) and follow up with alcohol to thoroughly clean the physical item.

2. Emphasis should be placed on areas of the physical item that tend to be exposed to or collect dirt. For example, on a vehicle, all doors, hood, trunk edges, fender wells, moldings door handles, or the like should be emphasized.

### Step 4. Install Panels

1. Do an exact tape-up.

2. Mark line up points on physical items taking into account an overlapping of the panels at sections where panels border each other. Depending on the physical item being covered, the overlapping can vary.

3. It is recommended that the installation start at the rear of the physical item and work to the front. However, the installation can start at the front of the physical item and work to the rear. As stated above, the panels can overlap. The amount of overlap depends on factors that can include, for example, intended use, environment of use, the type and size of the physical item, and the type of substrate, laminate or ink used. The overlap can range from about 0.75 inches to about 3 feet depending on the application and the factors listed above. In some instances, the overlap can be between about 1.25 inches and about 4.0 inches.

4. At border sections where panels overlap, the panels can be bonded using an open flame. For example, a snap torch can be used to heat the area of overlap to more effectively heat the laminate and seal and adhere the overlapped panels together.

5. During and after an installation of a panel, the panel may need to be cut. When cutting, be sure not to cut on a body or any plastic parts of the physical item as it can leave a permanent mark.

6. Heat in all edges & relief cuts to smooth the edges.

7. Look over the installation carefully.

8. Check for lifting in any convex or concave curves and reheat, if necessary.

### Step 5. Install Window Perforation (If Needed)

1. Some physical items may include glass that can be covered with a perforated material commonly used on glass in the industry having the pattern printed thereon. If glass is to be covered, the glass should be cleaned with glass cleaner. Preferably, no Ammonia is used. This cleaning can be followed with a wipe down of the glass of Isopropyl Alcohol.

2. Cut the Perforated material 1/16 of an inch from the edge to ensure it does not get caught in the window rubbers.

3. Run rivet brush around edges to ensure adhesion.

4. When cutting, make straight cuts.

### Step 6. Application of Quick Removal Preparation

1. If a layer being applied is not a top, outermost layer, then a quick removal preparation, such as a petroleum distillate preparation, can be applied to the installed layer such that the next layer applied upon the installed layer can be secured thereto to allow multi-layering, while permitting easy peeling away of the next layer. The petroleum distillate can include a friction reducing additive. For example, the additive can be a polymer having a low coefficient of friction. The polymer can be at least one of polytetrafluoroethylene, perfluoroalkoxy, and fluorinated ethylene propylene. With the petroleum distillate applied between the multiple printed laminated vinyl adhesive both multiple layering and assist in rapid removal can be achieved.

2. The preparation can be applied with a clean cloth or by spraying each section to aid in rapid removal. Alternating areas can be left free of the preparation to permit adhesion before adding subsequent layers.

To facilitate easy of removal of each layer, a peel tab can be created that can be the apparatus for, and demarcates the location to begin, peeling away an outer vinyl layer to reveal a differing inner layer in an expeditious manner. The peel tab can be created by the discrete folding over of a corner of the outermost border section thereby blocking the adhesive and creating a start point that is barely perceptible upon inspection, for the quick peeling off of a layer.

Steps 1 and 4-6 can be repeated for each additional layer.

### Step 7. Reinstall Removed Items (If Necessary)

1. Once all the layers are installed, any removed items can be reattached. Be careful not to damage the installed panels.

2. Analyze the installed panels looking for any areas that may fail. Examples of places to inspect on a vehicle include: fender wells, all edges, door handles, or the like.

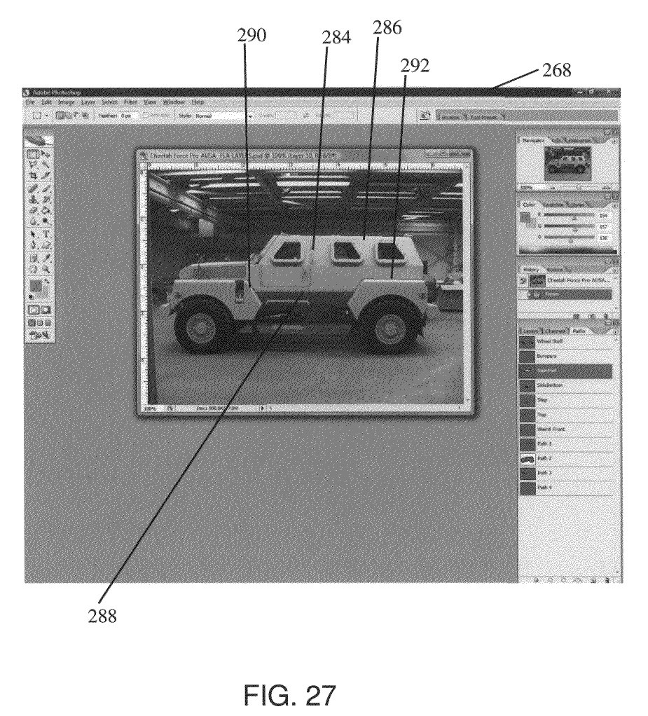

As described above, the panels can be installed on a physical item, so that the panels overlap each other. FIG. 27 illustrates two panels generally designated 150, 160 that can be placed on a physical item such as a structure or a vehicle. When placed on the physical item, the two panels 150, 160 can have an overlap generally designated 170. Each panel can have a length L. As shown in FIG. 27, the length L for each panel 150, 160 can be the same; however, in other embodiments the lengths of the panels that are to be placed beside each other can have different lengths.

First panel 150 can have a first side 152 and a second side 154. A portion of each side 152, 154 can be designated as an overlap area 156, 158, respectively. The overlap areas 156 and 158 can run the length L of first panel 150. Overlap area 156 can have a width with a distance 0₁ and overlap area 158 can have a width with a distance 0₂. Distance 0₁ and distance 0₂ can be the same or different. Similarly, second panel 160 can have a first side 162 and a second side 164. A portion of each side 162, 164 can be designated as an overlap area 166, 168, respectively. The overlap areas 166 and 168 can run the length L of second panel 160. Overlap area 166 can have a width with a distance 0₂ and overlap area 168 can have a width with a distance 0₃. Distance 0₂ and distance 0₃ can be the same or different. Each overlap area 156, 158, 166, 168 can contain portions of the pattern printed on the respective panels 150, 160.

First panel 150 can be installed with overlap area 156 overlapping another panel (not shown) or it can be applied directed to the physical item with no overlap. Once installed, the second panel 160 can be installed such that overlap area 166 of the second panel 160 extends over overlap area 158 of the first panel 150 to create overlap 170. This overlap 170 helps to ensure good coverage, for example, of the physical item on which the panels 150, 160 are placed. As described above, the distance 0₂ of overlap 170 and the distances 0₁, 0₃ depend on factors that can include, for example, intended use, environment of use, the type and size of the physical item, and the type of substrate, laminate or ink used. The overlap 170 can range from about 0.75 inches to about 3 feet depending on the application and the factors listed above. Overlap area 168 of second panel 160 can overlap another panel (not shown). Alternatively, overlap area 168 of second panel 160 does not have to overlap another panel.

As stated above, each vinyl adhesive layer can have a pattern thereon that is a camouflage pattern. These camouflage patterns can be any type of camouflage pattern. For example, the camouflage patterns can include the site-specific camouflage patterns described in more detail below.

The process of creating a site-specific camouflage pattern can begin with a photographic image of a specific local terrain, nautical position, or airspace where a physical item will be located or operating. Alternatively, the photographic image can contain environmental characteristics which would be found in the intended operating environment of the physical item instead of being a specific image from the specific location of the physical item. As stated above, the physical item can include, but is not limited to any and all types of vehicles (land, air and sea, and rail/manned & unmanned), aircraft, watercraft, structures, buildings, pipes and piping, equipment, weapons, hardware, and other items used for military or other purposes.

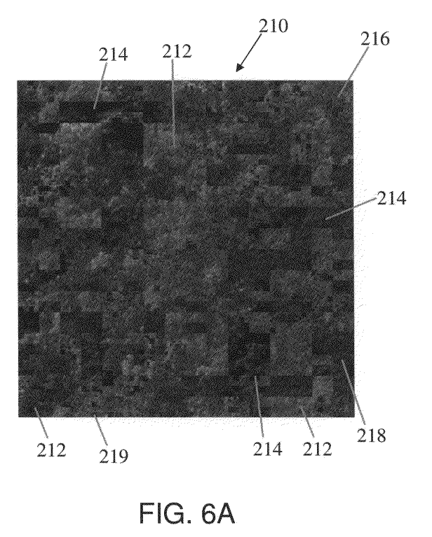

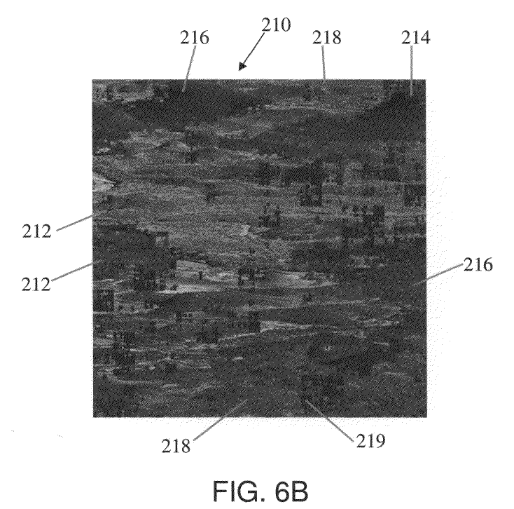

The photographic image can be digital and can then be manipulated such that site-specific photographic camouflage contains unnaturally occurring image distortions to aid in inhibiting the ability to easily distinguish proper depth of field perception. For example, FIGS. 6A and 6B illustrate different camouflage patterns generally 210, each of which includes portions or areas 212 of one or more photographic images that are site-specific for the intended operating environment in which the camouflage is to be used. The areas 212 can have different magnifications having different focal lengths creating distortions that are configured in disruptive patterns 214. For example, a specific area 216 of the areas 212 of one or more photographic images can be in focus at one focal length, while another specific area 218 of the areas 212 of one or more photographic images can have a different focal length that makes it more magnified. Further, micropatterns 219 can be added to further distort the image. The disruptive patterns 214 can be any shape from a structured shape to a generally amorphous shape as can be created by a pixel matrix.

Further, the camouflage 210 can have disruptive patterns having areas with an improper focal length that creates a blurred distortion that appears to be out of visual focus. For example, specific area 218 of the areas 212 of one or more photographic images can include portions of images that have an improper focal length and are slightly out of focus. Such disruptive patterns with blurred distortions can create further visual confusion for an observer and/or for an electronic or optical device. For example, for a physical item that contains images having multiple focal lengths and/or image portions having improper focal lengths that creates an out of focus portion beside an image portion that has a proper focal length and is in focus, an optical or electronic device that detects such a physical item will have difficulty focusing on the physical item and/or determining a correct distance between the device and the physical item. Such visual confusion aids in camouflaging and protecting the physical item.

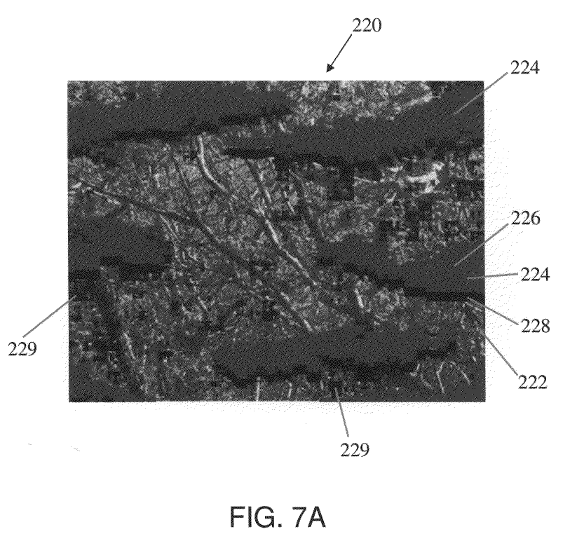

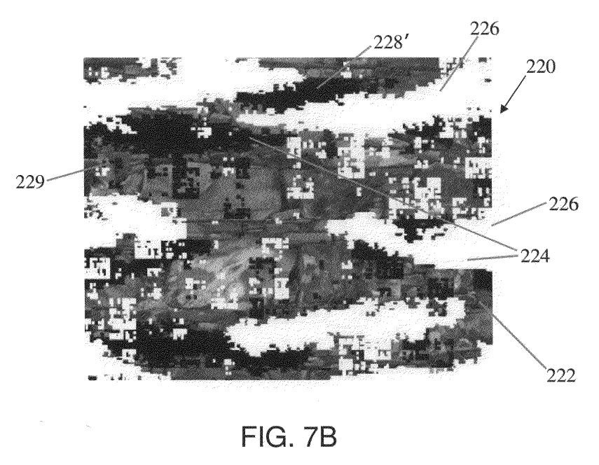

FIGS. 7A and 7B illustrate other examples of a camouflage pattern generally 220, each of which includes photographic image 222 that is site-specific to the intended operating environment in which the camouflage is to be used. One or more disruptive patterns 224 of one or more colors selected from a range of colors can be placed over the photographic image 222 to create distortions. The range of colors can come from the palate of colors in the photographic image and/or an operating environment in which the camouflage is intended to be used. For example, the disruptive pattern 224 as shown in FIG. 7A can include a first portion, or top portion, 226 that overlays a shadow portion 228. Alternatively, the disruptive patterns 224 can include a first disruptive pattern 226 and a second disruptive pattern 228′ that may overlap some, but do not necessarily mirror each other as shown in FIG. 7B. Further, micropatterns 229 can be added to further distort the photographic image. There are at least two disruptive patterns that can be included in the camouflage pattern. The disruptive patterns 224 can be any shape from a structured shape to a generally amorphous shape. The randomness of such shapes may be limited by the pixel matrix of the image, if it is a digital image. Placement of unnaturally occurring colored disruptive patterns and micro patterns on the original site-specific photographic image disrupts the contour of the camouflaged object and breaks up the visual pattern and distinguishable shape of the object.

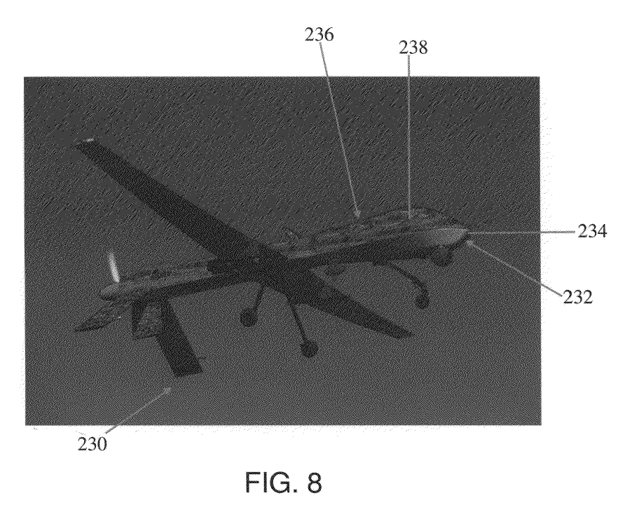

When applied, the camouflage can create multiple viewing angles. For example, as shown in FIG. 8, a drone plane, generally 230, can have an underside 232 that has a site-specific visually distorted blue sky image 234 thereon and a topside 236 that has site-specific visually distorted image 238 having the characteristics of the surrounding landscape as looking down from above. The image 238 of the drone plane 230 in FIG. 8 has on its top side 236 unnaturally occurring magnifications and disruptions of site-specific photo images similar to the camouflage 210 of FIG. 7B.

Through the use of micropatterns and disruptive patterns of colored shapes and/or side-by-side areas within the camouflage that contain photo images at competing or contrasting focal lengths, a visual confusion and a disruption, or breaking up of the outline of the camouflaged object can be achieved. In this manner, the camouflage 210, 220 can be created with a generally seamless continuation of other naturally occurring features and landscapes that continue into the horizon. A synthesized but realistic perspective arrangement in a given environment is not necessarily sought. Rather, a principal purpose is to cause visual confusion by disguising and breaking up the recognizable form of the object. Another purpose is to inhibit depth perception by interfering with primary ways one perceives depth.

For example, depth from focus can be inhibited. The lens of the eye can change its shape to bring objects at different distances into focus. Knowing at what distance the lens is focused when viewing an object means knowing the approximate distance to that object. The discontinuous pattern of the camouflage creates no regular continuously repeatable pattern coinciding with the natural environment. This jumble of shapes goes against the Gestalt Law of continuity, and makes it harder to see.

Another example, depth from relative size can be inhibited. An automobile that is close to a person looks larger to that person than one that is far away; the human visual system exploits the relative size of similar (or familiar) objects to judge distance. The pattern of differing focal differences within the created pattern described herein creates visual confusion by making it harder to judge relative size.

Depth perceived from motion can also be inhibited. A form of depth from motion, kinetic depth perception, is determined by dynamically changing object size. As objects in motion become smaller, they appear to recede into the distance or move farther away; objects in motion that appear to be getting larger seem to be coming closer. This is a form of kinetic depth perception. Using kinetic depth perception enables the brain to calculate time to crash distance (TTC) at a particular velocity. When driving, we are constantly judging the dynamically changing headway (TTC) by kinetic depth perception. The patterns described herein confuse or complicate the determination of kinetic depth perception by the inherent differing magnifications or disruptions rendering the true object size more difficult to perceive, and thereby interfering with kinetic depth perception.

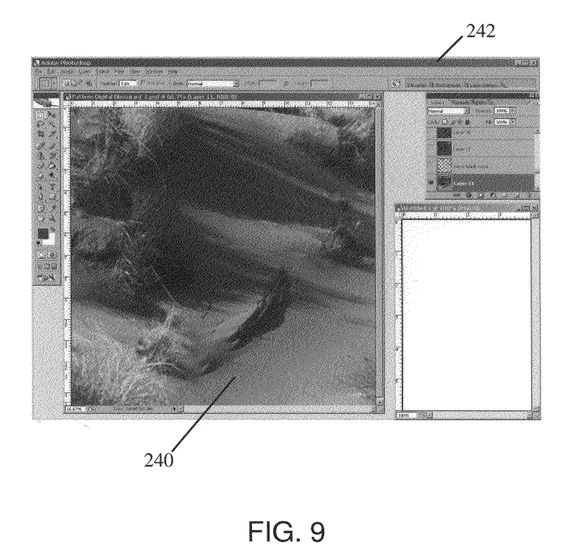

Referring to FIGS. 9-15, a process for creating a camouflage from a site-specific digital photographic image using colored disruptive patterns is described in detail. First, a digital photographic image 40 is procured or obtained that can be used in an intended operating environment. For example, suitable high megapixel digital still photographs of the specific terrain, nautical position, or airspace which the user will be operating can be acquired. These digital still photographs can be obtained in different manners and using different equipment. For example, the digital still photographs can be obtained through digital still cameras, high definition and standard definition video cameras, or satellite imagery.

Once obtained, the digital photographic image 240 in the form of a high megapixel digital still photograph, for example, is the starting point for the camouflage, concealment or deception pattern to be created and later applied to a physical item such as a military vehicle (land, air or sea), structure, weapon, hardware, fabric, netting, mesh, or equipment. A suitable digital photographic image or images 240 can contain a very precise match to the specific operating environment by being high megapixel photo duplicates of the environment. Alternatively, a suitable digital photographic image or images 240 can contain environmental characteristics which would be found in the intended operating environment of the physical item The photographs can be from different viewing perspectives to allow the capability to design appropriate camouflage that will be effective from different viewing perspectives (when viewed from above, on any side, or when necessary viewed from below). For example, as illustrated in FIG. 9, if the physical item to be camouflaged is to reside or operate within a desert environment, the digital photographic image 240 can reflect the general characteristics of a desert environment or can be from the actual desert location in which the camouflaged physical item will reside and/or operate.

The digital photographic image 240 is opened on the computer in an image-editing program 242 as shown in FIG. 9 so that the digital photographic image 240 can be enhanced to create a camouflage pattern for concealment or deception purposes. The image-editing program can be, for example, PHOTOSHOP®) offered by Adobe Systems Incorporated, San Jose Calif. Other image-editing programs can include equivalent photo manipulation and editing software programs such as PAINT.NET® and PICASA®, or the like, or in the case of video footage the image-editing programs can include appropriate video editing software programs that will produce a digital still frame photographic image.

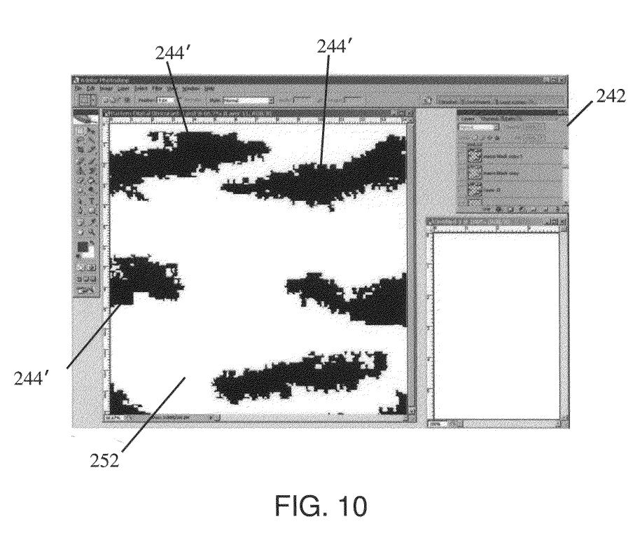

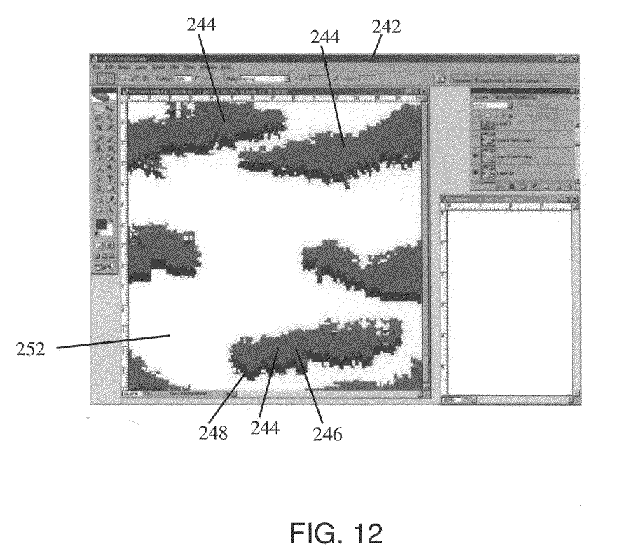

Next, the digital photographic image 240 can be manipulated by adding “disruptive patterns” to break-up or hide the contour of the physical item to be camouflaged or concealed as an aid in causing visual confusion. As shown in FIGS. 10-12, the imaging-editing program 242 can be used to generate a disruptive pattern 244 (see FIG. 12) on a gray scale 252 that can be placed over the digital photographic image 240. As shown in FIG. 10, shapes 244′ can be generated in the image editing program 242 to create the foundation of the disruptive pattern 244 (see FIG. 12). The disruptive pattern 244 can contain any shapes. As shown in FIG. 10, the shapes 244′ of the disruptive pattern can be generally amorphous. Alternatively, in some embodiments, the shapes 244′ can be specific geometrical structures.

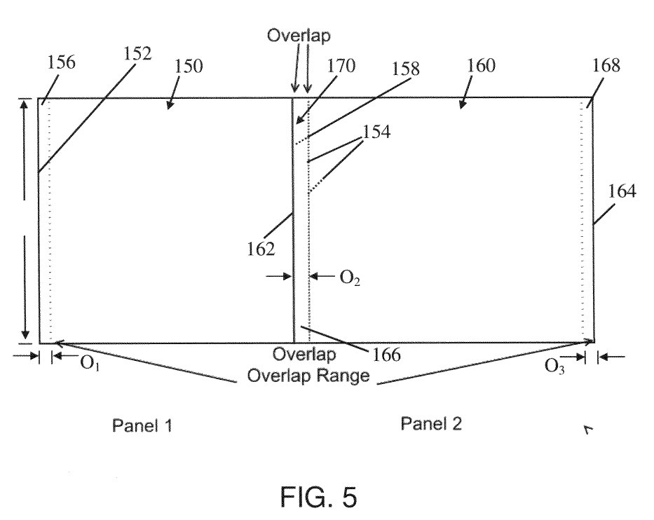

The shapes 244′ of the disruptive pattern shown in FIG. 5 can be of a size that is relative to the scale and size of the digital photographic image 240 (see FIG. 9) so as to not overwhelm the digital photographic image 240. In a similar manner, the proximity, or distance, between the shapes 244′ of the disruptive pattern, can be close enough so as to facilitate the creation of visual confusion when positioned on the digital photographic image 240, but far enough apart from each other to not overwhelm the digital photographic image 240. For this reason, the size and shape of the shapes 244′ can affect the number of shapes 244′ within a given disruptive pattern.

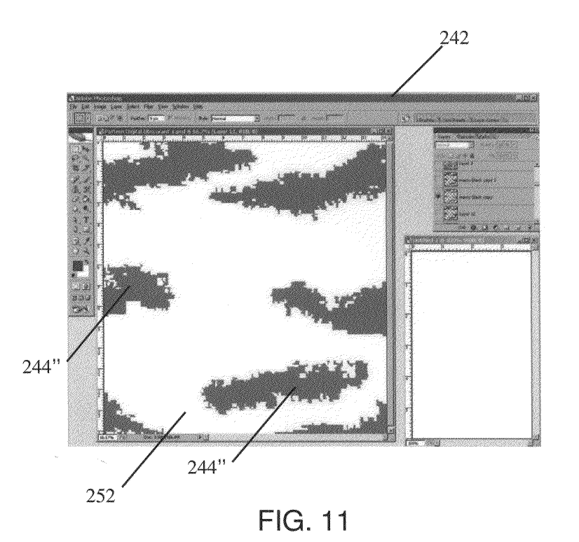

The shapes 244′ of the disruptive pattern shown in FIG. 10 can be colored to create colored shapes 244″ as shown FIG. 11. The one or more colors can be selected from a range of colors suitable for the intended operating environment in which the camouflage is to be used. For example, the one or more colors can be selected from a range of colors from the digital photographic image 240 and/or the operating environment in which the camouflage is intended to be used. More than one color can be used to color the different shapes. For example, some of the shapes can be one color and other shapes can be another color as shown in FIG. 7B.

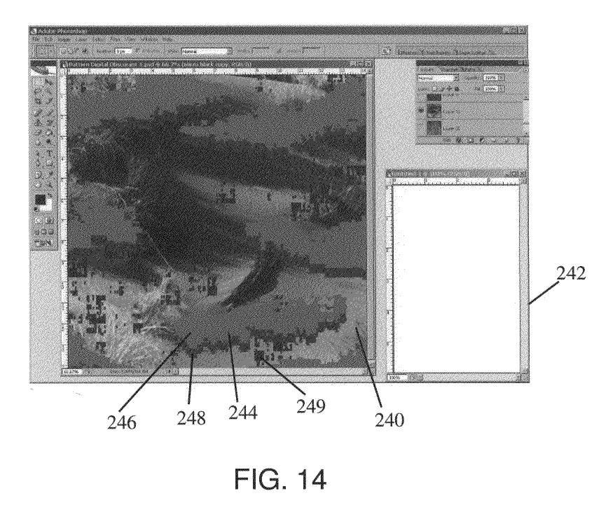

To create the final disruptive pattern 244 as used in the example of a camouflage pattern 250 shown in FIG. 14, the disruptive pattern 244 can include a top portion 246 and have a shadow portion 248 added to mirror or shadow the top portion 246 as shown in FIG. 12. The shadow portion 248 can be a darker shade or color as compared to the top portion 246. The shadow portion 248 can underlie the top portion 246 so as to create a shadow effect. The shadow effect of the top portion 246 and the shadow portion 248 add depth to the disruptive pattern 244 to further facilitate the visual confusion caused by the disruptive pattern 244.

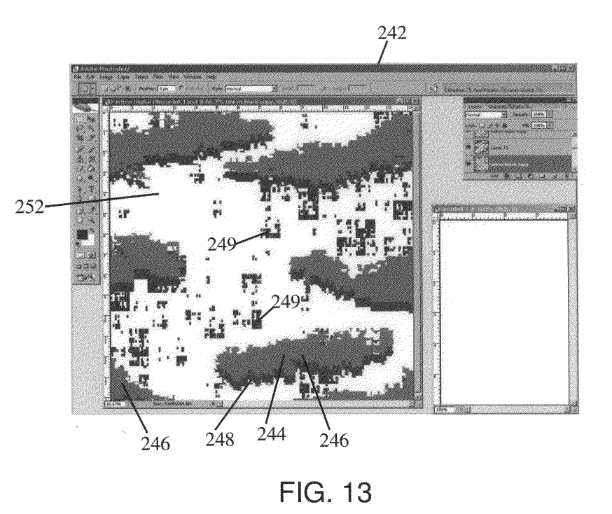

As shown in FIG. 13, additional micropatterns 249 can be added to increase the visual confusion. The additional micropatterns 249 are smaller patterns than the disruptive patterns 244 and can be a generally amorphous shape. The micropatterns 249 can include one or more additional colors not used in the disruptive pattern from the range of colors from the digital photographic image 240 and/or the operating environment in which the camouflage is intended to be used. The image-editing program can include computer assisted photo illustration software tools to add these micropatterns 249 to the suitably chosen digital photographic image 240. The micropatterns 249 can be randomly dispersed over the area of the field of the digital photographic image 240 in the camouflage pattern 250 as shown in FIG. 14. As shown in FIG. 14, the micropatterns 249 when added to together with disruptive pattern 244 should not create patterns so dense as to overwhelm the digital photographic image 240 of the camouflage pattern 250.

As shown in FIGS. 10-13, after the selection of the digital photographic image 240, the creation of one or more colored disruptive patterns 244 and the micropatterns 249 can be accomplished in the image-editing program 242 on a gray scale background 252. Once the disruptive patterns 244 and the micropatterns 249 are created, the digital photographic image 240 can be opened again in the image-editing program 242 and the disruptive pattern 244 and micropatterns 249 can be configured on the digital photographic image 240 to create the camouflage pattern 250. In this manner, a digital photograph of the specific real operating environment can be manipulated to cause visual confusion due to disruptive patterning.

Once a suitable digital photographic image 240 of the operational environment has been acquired, and it is enhanced to improve its camouflage effect, digital copies of the created photographic camouflage pattern 250 can be saved at varying sizes for different sized applications on the computer or a memory device, such as a compact disk, a floppy disk, a portable zip drive, a memory drive, or the like. A “proof” sample can be printed out at this stage to check and see if color, clarity, and depth are achieved.

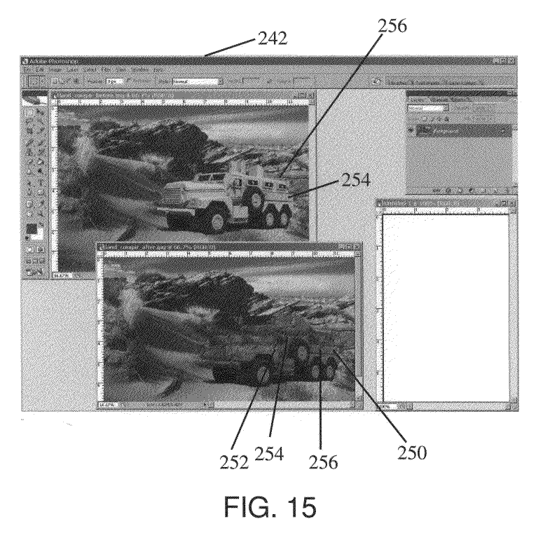

Next, a mock-up can now be created using the image-editing program 242 as shown in FIG. 15. Images of the particular physical item 254, such as a vehicle can be opened. The images of physical item 254 are digital, scaled-down versions of the vehicle for which the camouflage pattern 250 is designed. The images of physical item 254 can serve as an object template 256. This image can be a true to scale template. Therefore, when the camouflage is taken to a direct application, the measurements remain correct when printed in actual size. Lines can be added to the object template 256 to identify where the panels of camouflage would be on the vehicle.

The appropriate size of the previously saved photographic camouflage pattern 250 that best corresponds with the size of the physical item 254 to be camouflaged can be chosen and applied to the object template 256. Appropriate shading based on the shadows created by the physical item 254 can be used to create a general likeness of the physical item 254 as it would appear upon being camouflaged. This shading facilitates the determination of the viability of the created camouflage pattern. If the desired camouflage effect is achieved, further steps can be taken to create a camouflage material which will be described in greater detail below.

Alternatively, a process for creating a camouflage from a site-specific digital photographic image employing distortion disruptive patterns of images having different focal lengths can be used. In one embodiment, such a camouflage pattern can be created by placing smaller photographs or photograph sections layered over the original, or base, digital photographic image to achieve the desired disruptive effect that aids in the cause of visual confusion by inhibiting normal depth perception. This use of photo-over-photo technique achieves both a disruptive effect and makes the camouflage have a visual confusing effect at different focal distances.

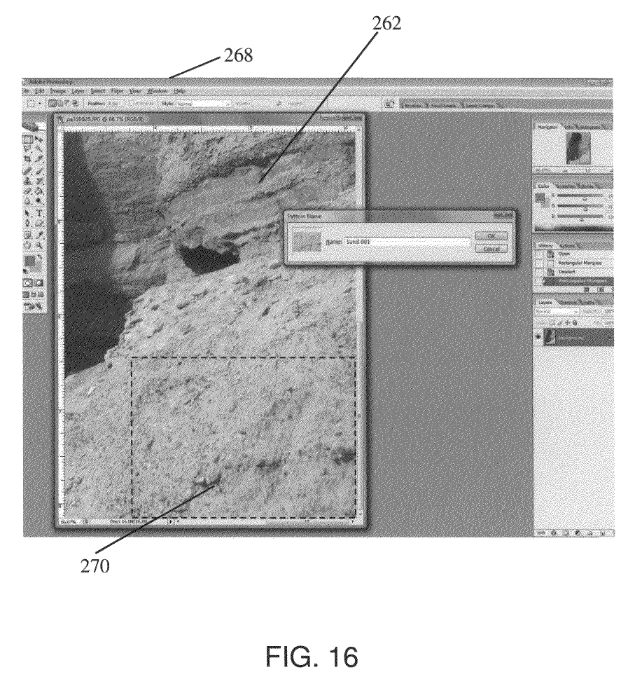

In the embodiment shown in FIGS. 16-29, a process for creating a camouflage from site-specific digital photographic images using disruptive patterns of images having different focal lengths is described in more detail. As in this example, the camouflage pattern can be developed from a plurality of site-specific digital photographic images. First, two or more digital photographic images are procured or obtained that can be used in an intended operating environment. The digital photographic images can be site-specific photographic images.

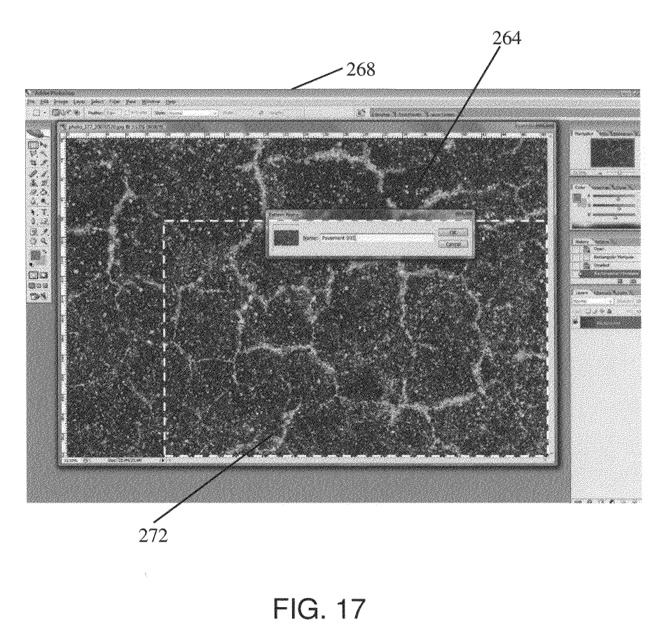

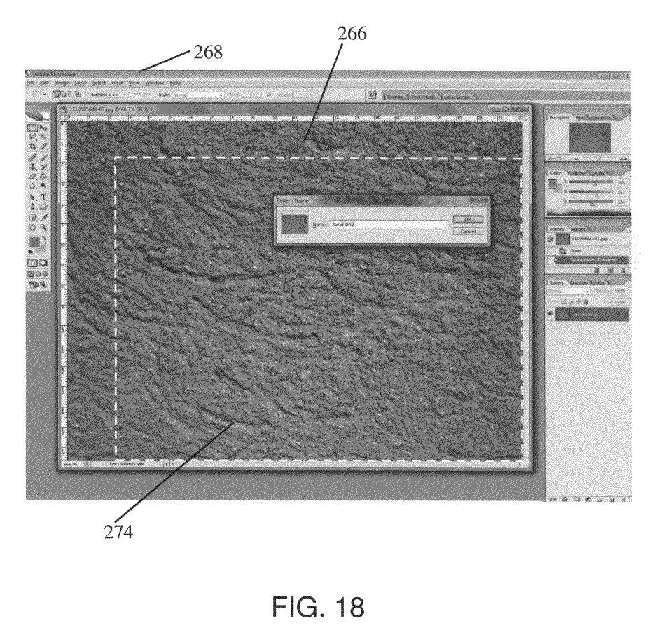

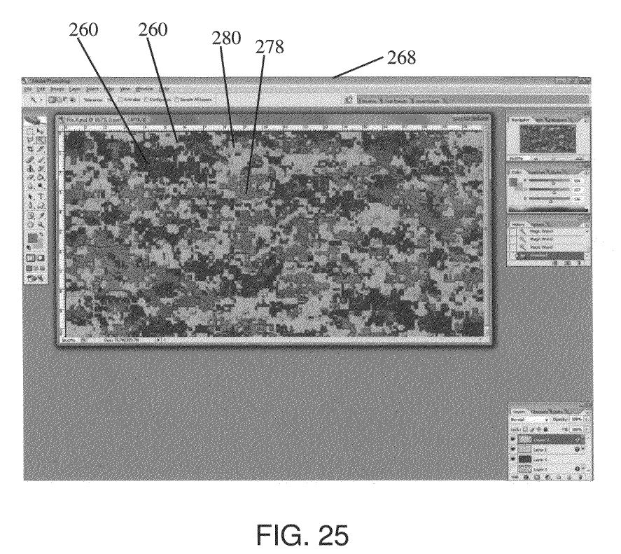

In the example shown in FIGS. 16-29, desert site-specific camouflage 260 (see FIG. 25) is being created from three site-specific photographic images 262, 264, 266 (see FIGS. 16-18, respectively). The digital photographic image 262 shown in FIG. 16 is a site-specific image of a portion of a sandstone landscape. The digital photographic image 264 shown in FIG. 17 is a site-specific image of a portion of weather worn desert pavement at a shorter focal length than that of digital photographic image 262. The digital photographic image 266 shown in FIG. 18 is a site-specific image of a different portion of a sandstone landscape than that of the digital photographic image 262. As can be seen, the digital photographic image 266 has a much shorter focal length than the digital photographic image 262. Thus, three different photographic images 262, 264, 266 having different focal lengths are provided. Further, the three different photographic images 262, 264, 266 are of site-specific elements common to the intended operating environment in which the developed camouflage will be used.

Each digital photographic image 262, 264, 266 can be opened on the computer in an image-editing program 268 as shown in FIGS. 16-18 so that the digital photographic images 262,264, 266 can be manipulated to create a camouflage pattern for concealment or deception purposes. In FIG. 16, the digital photographic image 262 is opened in the image-editing program 268 on a computer and an image of an area 270 of the digital photographic image 262 can be isolated to be used in creating the camouflage. Similarly, the digital photographic image 264 is opened in the image-editing program 268 as shown in FIG. 17 and an image of an area 272 of the digital photographic image 264 can be isolated using the image-editing program 268. The digital photographic image 266 can also be opened in the image-editing program 268 as shown in FIG. 18 and an image of an area 274 of the digital photographic image 266 can be isolated to be used in creating the camouflage.

Again, each digital photographic image 262, 264, 266 is of a different area with a different focal length resulting in different magnification. If necessary, the isolated images of the respective areas 270, 272, 274 of the digital photographic images 262, 264, 266 can be further enhanced to differentiate the magnifications.

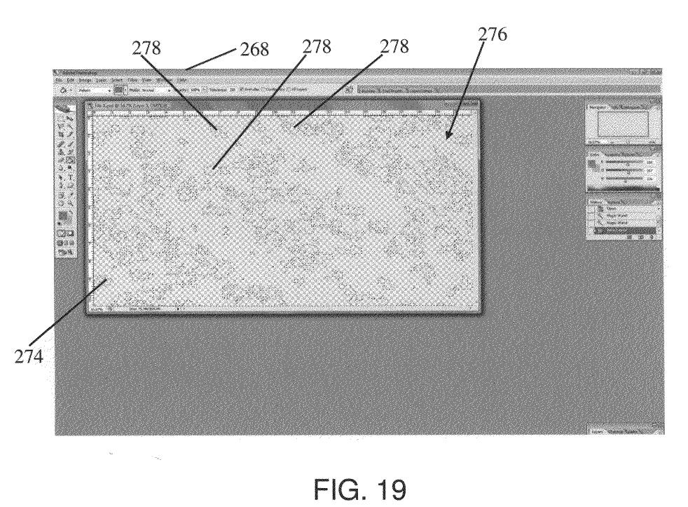

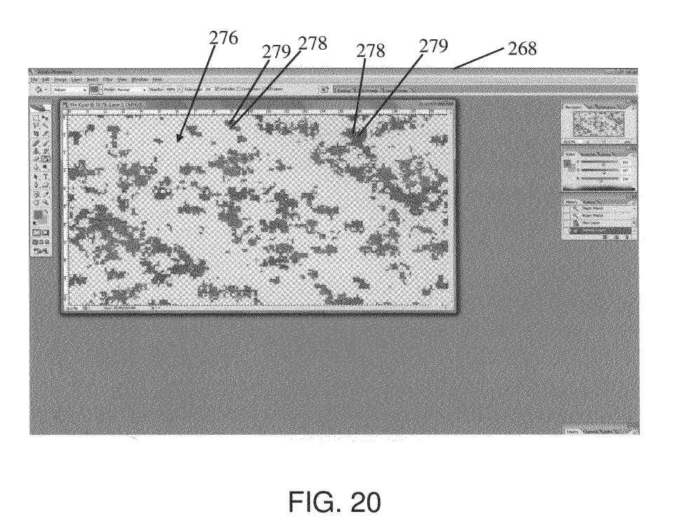

Before or after the images of the respective areas 270, 272, 274 of the digital photographic images 262, 264, 266 are isolated, a template of disruptive patterns can be created on a gray scale generally 276 (see FIG. 19) using the image-editing program 268 with different disruptive patterns identified to receive a different respective isolated image of the respective areas 270, 272, 274 of the digital photographic images 262, 264, 266. As shown in FIG. 19, a first disruptive pattern 278 can be generated or added to the gray scale 276. As described above, the disruptive pattern can be any shape. In the embodiment shown, the disruptive pattern 278 is a generally amorphous shape. This first disruptive pattern 278 can receive portions of an image from one of the areas 270, 272, 274 from one of the respective digital photographic images 262, 264, 266. As shown in FIG. 20, the image-editing program 268 can be used to drop in portions 279 of the image of the area 274 from the digital photographic image 266. In this manner, the image of the area 274 is applied to the first disruptive pattern.

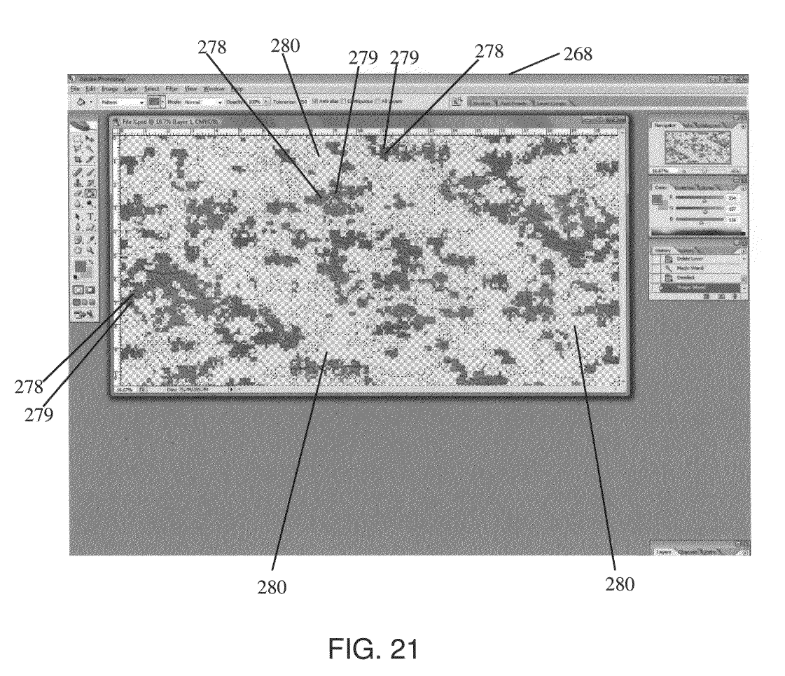

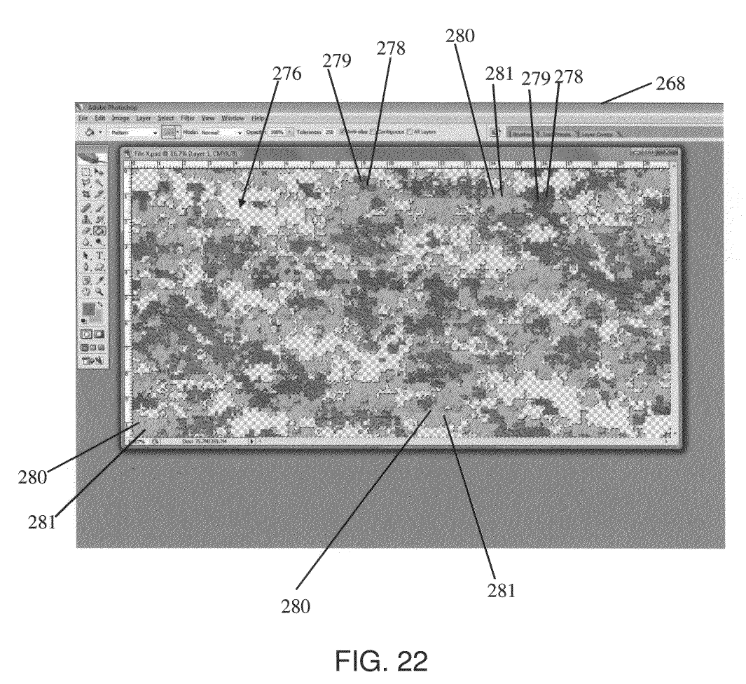

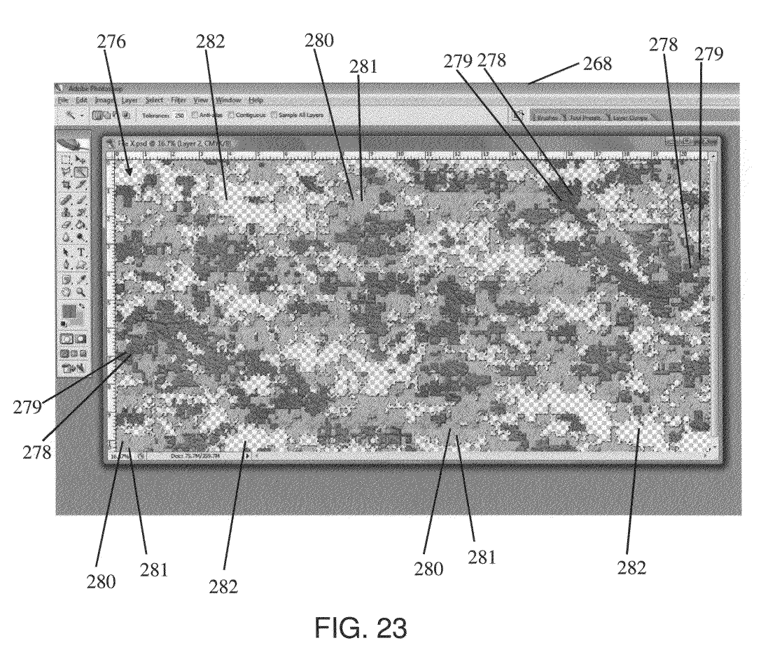

As shown in FIG. 21, a second disruptive pattern 280 can be generated or added to the gray scale 276. The disruptive pattern can be any shape. In the embodiment shown, the disruptive pattern 280 is a generally amorphous shape. This second disruptive pattern 280 resides in areas not occupied by the first disruptive pattern 278 containing the portions 279 of the image of the area 274. The second disruptive pattern 280 can receive portions of one of the remaining images of the areas 270, 272 from one of the respective digital photographic images 262, 264. As shown in FIG. 22, the image-editing program 268 can be used to drop in portions 281 of the image of the area 270 from the digital photographic images 262. In this manner, the image of the area 270 is applied to the second disruptive pattern.

As shown in FIG. 23, a third disruptive pattern 282 can be generated or added to the gray scale 276. The disruptive pattern can be any shape. In the embodiment shown, the disruptive pattern 282, like the other disruptive patterns 278, 280, is a generally amorphous shape. This third disruptive pattern 282 resides in areas not occupied by the first and second disruptive patterns 278, 280 containing the portions 279, 280 of the image of the respective areas 274, 270. Since only three disruptive patterns are used in this example, the third disruptive pattern 282 resides in any area not occupied by the other two disruptive patterns 278, 280.

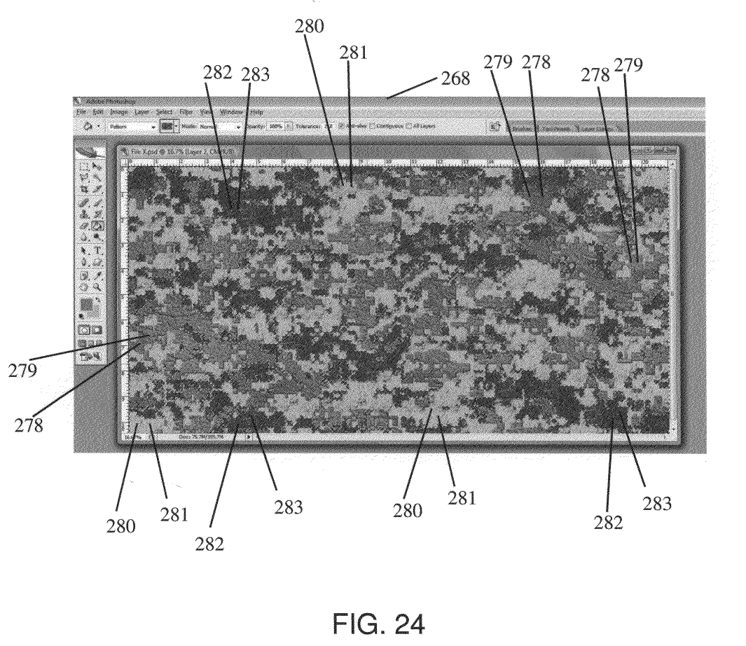

The third disruptive pattern 282 can receive portions of the remaining image of the area 272 from one of the respective digital photographic images 264 not used in the other disruptive patterns 278, 280. As shown in FIG. 24, the image-editing program 268 can be used to drop in portions 283 of the image of the area 272 from the digital photographic images 264. In this manner, the image of the area 272 is applied to the third disruptive pattern.

Once the last disruptive pattern has an image applied to it and any clean-up using the image-editing program 268 is conducted, a camouflage pattern 260 is created as shown in FIG. 25. The camouflage pattern 260 has three disruptive patterns 278, 280, 282 having different images of areas 270, 272, 274 from different site-specific photographic images 262, 264, 266 that have different focal lengths to create visual confusion for concealment and deception. One or more of the different focal lengths of such images can be improper focal lengths (not shown) that cause those images to appear out of focus. Generally, it should be understood that such camouflage patterns can include two or more disruptive patterns. For example, four or five patterns can be used in make such camouflage.

Digital copies of the created photographic camouflage pattern 260 can be saved at varying sizes for different size applications on the computer or a memory device, such as a compact disk, a floppy disk, a portable zip drive, a memory drive, or the like. A “proof” sample can be printed out at this stage to check and see if color, clarity, and depth are achieved.

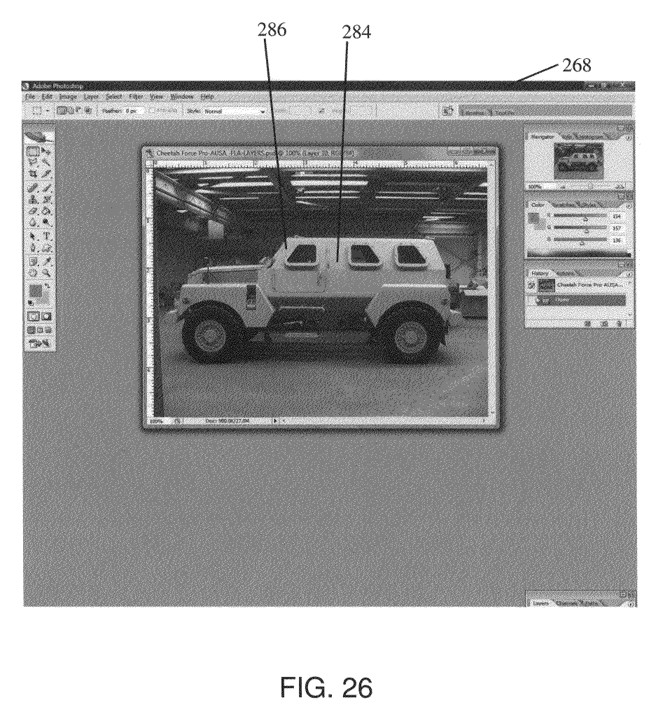

Next, a mock-up can now be performed using the image-editing program 268 as shown in FIG. 26-29. Images of the particular physical item 284, such as a vehicle, can be opened in the image-editing program 268 on the computer. The images of physical item 284 are a digital, scaled down versions of the vehicle for which the camouflage pattern 260 can be designed. The images of physical item 284 can serve as an object template 286. This image can be a true to scale template. Therefore, when the camouflage 260 is taken to a direct application, the measurements remain correct when printed in actual size. As shown in FIG. 27, the object template 286 of the physical item 284 is “pathed” by adding lines such as lines 288, 290, 292 to the object template 286 to identify where the panels of camouflage 260 would be affixed onto the vehicle.

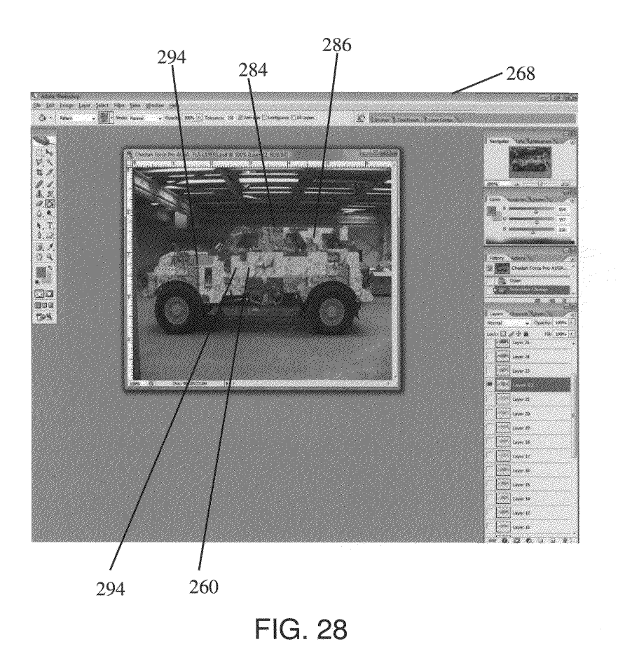

As shown in FIG. 28, the appropriate size of the previously saved photographic camouflage pattern 260 that best corresponds with the size of the template 286 of the physical item 284 to be camouflaged can be chosen. Using the image-editing program, the image or images of the camouflage 260 can then be divided into sections to create appropriately sized panels 294. The panels 294 can be applied to the object template 86 using the image-editing program 268.

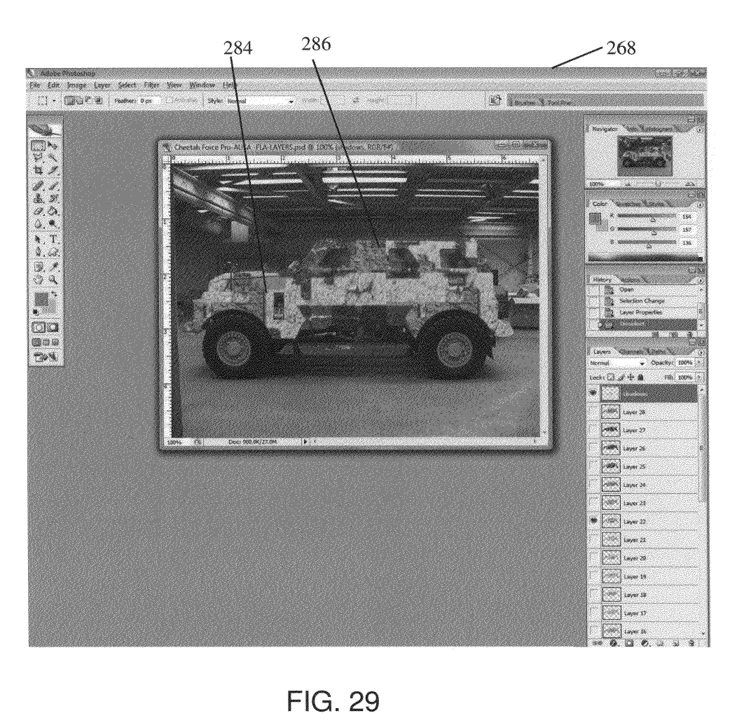

As shown in FIG. 29, appropriate shading based on the shadows created by the physical item 284 can be added to the template 286 using the image-editing program 268 to create a general likeness of the physical item 284 as it would appear upon being camouflaged with the created pattern to determine its viability. Again, this shading adds realism to test the effectiveness of the finished design without have to create a finished product. If the desired camouflage effect is achieved, further steps can be taken in creating a camouflage material which will be described in greater detail below.

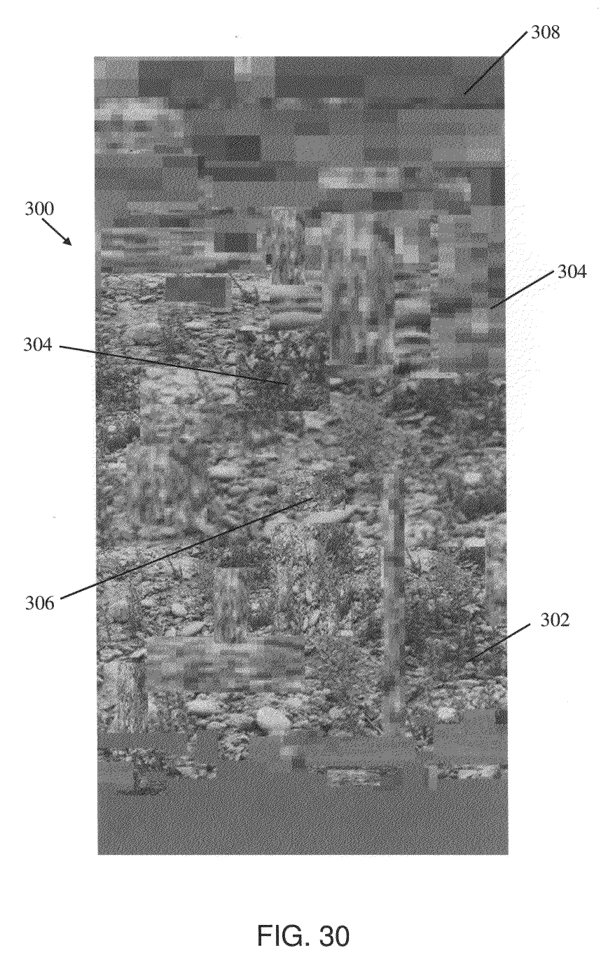

In an embodiment shown in FIG. 30, a camouflage pattern 300 can be created by taking a base digital photographic image 302 and creating disruptive patterns 304, 306, 308 of distortions through the use of magnifications or demagnifications of portions of the digital photographic image 302. Such disruptive patterns 304, 306, 308 of distortions can make use of portion of image 302 having improper focal lengths to create disruptive patterns that are out of focus. The disruptive patterns 304, 306, 308 of distortions can be generated and layered over the base digital photographic image 302 using an image-editing program on a computer to achieve the desired disruptive effect in the camouflage 300 that aids in creating visual confusion by inhibiting normal depth perception.

As shown in FIG. 25, image 302 can have can have disruptive patterns 304, 306, 308 of different portions of the image 302 that have different focal lengths. For example, disruptive pattern 306 can have a longer focal length than the base image 302 with disruptive pattern 306 still being in focus. Disruptive pattern 304 can have an improper focal length that creates a blurred distortion that is somewhat out of focus. Further, disruptive pattern 308 can also have an improper focal length that creates a blurred distortion that is even more out of focus than the disruptive pattern 304. This use of photo-over-photo technique also achieves both a disruptive effect and makes the camouflage 300 have a visually confusing effect at different focal distances.

As described above, such disruptive patterns with blurred distortions can create further visual confusion for an observer and/or for an electronic and/or optical device. For example, an optical or electronic device that detects a physical item that contains images having multiple focal lengths and/or image portions having improper focal lengths that creates an out of focus portion will have difficulty focusing on the physical item and/or determining a correct distance between the device and the physical item. Such visual confusion aids in camouflaging and protecting the physical item.

Once the desired camouflage effect is confirmed as described above, a second proof can be printed at this stage to check and see if the appropriate color, clarity, and depth are still being achieved and the camouflage still is an ideal match for the operating environment. Next, using the image-editing program, the image of the camouflage can be divided into the panels as described hereinabove.

Some or all of these techniques and enhancements used in the camouflage embodiments described above can be used together or separately according to the desired effect or effects. The description provided below can be used with any of the camouflage embodiments described above, unless stated otherwise. The camouflage patterns, the methods of making the same and the different materials or substrates on which they can be used provide various ways to create visual confusion and deception for the physical items on which they are applied.

Embodiments of the present disclosure shown in the drawings and described above are exemplary of numerous embodiments that can be made within the scope of the appending claims. It is contemplated that the configurations of the quick change multi-layered visual deception systems and related methods can comprise numerous configurations other than those specifically disclosed. The scope of a patent issuing from this disclosure will be defined by these appending claims.

1. A quick change multi-layered deception system for visually disguising a physical item, the system comprising:
a first vinyl adhesive layer applied over a surface of a physical item, the first vinyl adhesive layer having a first pattern;
a second vinyl adhesive layer applied over the first vinyl adhesive layer, the second vinyl adhesive layer having a second pattern different from the first pattern; and
wherein the second vinyl adhesive layer is configured to be easily removable from the first vinyl adhesive layer.

2. The system according to claim 1, further comprising a quick removal preparation applied between the first vinyl adhesive layer and the second vinyl adhesive layer.

3. The system according to claim 2, wherein the quick removal preparation comprises a petroleum distillate.

4. The system according to claim 3, wherein the petroleum distillate includes a polymer having a low coefficient of friction.

5. The system according to claim 3, wherein the petroleum distillate includes a polymer that comprises at least one of polytetrafluoroethylene, perfluoroalkoxy, and fluorinated ethylene propylene.

6. The system according to claim 2, wherein the quick removal preparation is applied in alternating areas between the first vinyl adhesive layer and the second vinyl adhesive layer.

7. The system according to claim 1, wherein the first and second vinyl adhesive layers include panel sections.

8. The system according to claim 7, wherein the second vinyl adhesive layer includes a peel tab for each panel section configured to be the apparatus and demarcate the location to begin the peeling of the second vinyl adhesive layer from the first vinyl adhesive layer.

9. The system according to claim 8, wherein the peel tab comprises a discrete folded corner of the outermost border section of the second vinyl adhesive layer.

10. The system according to claim 7, wherein the first vinyl adhesive layer includes a peel tab configured to be the apparatus and demarcate the location to begin the peeling of the first vinyl adhesive layer from the surface of the physical item.

11. The system according to claim 10, wherein the peel tab comprises a discrete folded corner of the outermost border section of the first vinyl adhesive layer.

12. The system according to claim 1, wherein at least one of the first or second patterns is a pattern including at least one of a color, a camouflage pattern, repeating design, a non-repeating design, a deceptive design, or an outward physical characteristic of the physical item.

13. The system according to claim 1, wherein at least one of the first or second patterns is a camouflage pattern that comprises a site-specific digital photographic image.

14. The system according to claim 1 wherein at least one of the first or second patterns is a camouflage pattern that comprises:
a photographic image; and
a disruptive pattern of at least one color configured on the photographic image, the at least one color being selected from a range of colors from at least one of the photographic image or an operating environment in which the camouflage is intended to be used.

15. The system according to claim 14, wherein the camouflage pattern further comprises additional micropatterns configured on the photographic image, the micropatterns being smaller than the disruptive patterns.

16. The system according to claim 15, wherein the micropatterns include one or more additional colors selected from the range of colors, the one or more additional colors including colors not used in the disruptive pattern.

17. The system according to claim 15, wherein the camouflage pattern further comprises one or more additional disruptive patterns configured on the photographic image, the one or more additional disruptive patterns including one or more additional colors not used in the disruptive pattern and selected from the range of colors.

18. The system according to claim 1 wherein at least one of the first or second patterns is a camouflage pattern that comprises:
a base photographic image; and
one or more distorting disruptive patterns including images having different focal lengths configured on the base photographic image.

19. The system according to claim 18, wherein the base photographic image comprises a site-specific photographic image.

20. The system according to claim 18, wherein images having different focal lengths comprises one or more site-specific photographic images or portions of one or more site-specific photographic images.

21. The system according to claim 18, wherein the images having different focal lengths comprise portions of one or more different photographic images than the base photographic image.

22. The system according to claim 18, wherein the images having different focal lengths comprise portions of the base photographic image.

23. The system according to claim 18, wherein the different focal lengths include improper focal lengths that make the image appear to be out of focus.

24. The system according to claim 18, further comprising one or more additional disruptive patterns of at least one color from a range of colors from at least one of the base digital photographic image or an operating environment in which the camouflage is intended to be used.

25. The system according to claim 24, wherein the camouflage pattern further comprises additional micropatterns configured on the digital photographic image, the micropatterns being smaller than the disruptive patterns.

26. The system according to claim 25, wherein the micropatterns include one or more additional colors selected from the range of colors, the one or more additional colors including colors not used in the disruptive pattern.

27. The system according to claim 1 wherein at least one of the first or second patterns is a camouflage pattern that comprises:
a plurality of disruptive patterns;
each disruptive pattern including portions of an image having a different focal length than the focal lengths of the images included in the other disruptive patterns; and
the disruptive patterns integrated together to form the camouflage pattern.

28. The system according to claim 27, wherein the images having different focal lengths comprises one or more site-specific photographic images or portions of one or more site-specific photographic images.

29. The system according to claim 28, further comprising one or more additional disruptive patterns of at least one color from a range of colors from at least one of the site-specific photographic images or an operating environment in which the camouflage is intended to be used.

30. The system according to claim 29, wherein the camouflage pattern further comprises additional micropatterns configured on the plurality of disruptive patterns, the micropatterns being smaller than the disruptive patterns.

31. The system according to claim 30, wherein the micropatterns include one or more additional colors selected from the range of colors, the one or more additional colors being chosen from colors not used in the disruptive pattern.

32. The system according to claim 27, wherein the different focal length of at least one of the images in one of the disruptive patterns comprises an improper focal length that make the image appear to be out of focus.

33. The system according to claim 1, further comprising one or more other vinyl adhesive layers applied over the first and second vinyl adhesive layers, each of the one or more other vinyl adhesive layers having a different pattern from the layer preceding it.

34. A quick change multi-layered deception system for visually disguising a physical item, the system comprising:
one or more other vinyl adhesive layers applied successively over a surface of a physical item, each of the one or more other vinyl adhesive layers having a different pattern from the layer preceding it;
a quick removal preparation applied between each of the one or more vinyl adhesive layers; and
wherein each of the one or more vinyl adhesive layers is configured to be easily removable from the first vinyl adhesive layer.

35. The system according to claim 34, wherein the quick removal preparation comprises a petroleum distillate.

36. The system according to claim 35, wherein the petroleum distillate includes a polymer having a low coefficient of friction.

37. The system according to claim 38, wherein the petroleum distillate includes a polymer that comprises at least one of polytetrafluoroethylene, perfluoroalkoxy, and fluorinated ethylene propylene.

38. The system according to claim 34, wherein the quick removal preparation is applied in alternating sections between the one or more vinyl adhesive layers.

39. The system according to claim 34, wherein at least one of the first or second patterns is a pattern including at least one of a color, a camouflage pattern, repeating design, a non-repeating design, a deceptive design, or an outward physical characteristic of the physical item.

40. The system according to claim 34, wherein each of the one or more vinyl adhesive layers includes panel sections.

41. The system according to claim 40, wherein each of the one or more vinyl adhesive layers includes a peel tab for each panel section configured to be the apparatus and demarcate the location to begin the peeling of the second vinyl adhesive layer from the first vinyl adhesive layer.

42. The system according to claim 41, wherein the peel tab comprises a discrete folded corner of the outermost border section of the respective one or more vinyl adhesive layers.

43. The system according to claim 40, wherein the panel section of each of the one or more vinyl adhesive layers overlaps a bordering panel section.

44. The system according to claim 43, wherein the overlap comprises about one inch to about four inches.

45. A quick change multi-layered deception method for visually disguising a physical item, the method comprising:
providing a physical item;
applying a first vinyl adhesive layer applied over a surface of a physical item, the first vinyl adhesive layer having a first pattern;
applying a second vinyl adhesive layer over the first vinyl adhesive layer, the second vinyl adhesive layer having a second pattern different from the first pattern; and
wherein the second vinyl adhesive layer is configured to be easily removable from the first vinyl adhesive layer.

46. The method according to claim 45, further comprising applying a quick removal preparation between the surface of the first vinyl adhesive layer and the second vinyl adhesive layer.

47. The method according to claim 45, further comprising applying one or more other vinyl adhesive layers over the first and second vinyl adhesive layers, each of the one or more other vinyl adhesive layers having a different pattern from the layer preceding it.

48. The method according to claim 47, further comprising applying a quick removal preparation between each of the vinyl adhesive layers.

49. The method according to claim 45, further comprising creating a peel tab with a portion of at least one of the first vinyl adhesive layer and the second vinyl adhesive layer.

50. The method according to claim 45, wherein creating a peel tab further comprises discretely folding a portion of at least one of the first vinyl adhesive layer and the second vinyl adhesive layer to prevent the adhesive at the portion from securing to the physical item.

51. The system according to claim 45, wherein at least one of the first or second patterns is a pattern including at least one of a color, a camouflage pattern, repeating design, a non-repeating design, a deceptive design, or an outward physical characteristic of the physical item.

52. The system according to claim 45, wherein at least one of the first or second patterns is a camouflage pattern that comprises a site-specific digital photographic image.

53. The method according to claim 45, wherein each of the first and second layers comprises panels that overlap at border sections.

54. The method according to claim 53, further comprising heating the panels at the overlapped border sections with an open flame.

55. The method according to claim 53, wherein the overlap of the panels is between about 0.75 inches and about 3 feet.

56. The method according to claim 53, wherein the overlap of the panels is between about 1.25 inches and about 4.0 inches.

57. The method according to claim 53, wherein no registration lines are used to align the overlapping panels.

58. The method according to claim 45, further comprising removing any accessories from the physical item to be covered before applying the first vinyl adhesive layer.

59. The method according to claim 58, further comprising reinstalling any accessories from the physical item to be covered after applying the last vinyl adhesive layer.

60. The method according to claim 45, wherein the first and second vinyl adhesive layers are laminated.

61. The method according to claim 60, wherein the first and second vinyl adhesive layers are laminated with a non-gloss laminate.

62. A camouflage system for visually disguising a physical item, the system comprising:
at least one vinyl adhesive layer configured to be applied over a surface of a physical item, the at least one vinyl adhesive layer comprising:
a vinyl layer having a front and a back the vinyl layer having a camouflage pattern printed on the front;
a laminate secured over the front of the vinyl layer coating the printed camouflage pattern to provide non-shiny protection to the printed camouflage pattern and strengthen the at least one vinyl layer;
an adhesive layer secured to the back of the vinyl layer, the adhesive layer configured to secure the vinyl layer to the physical item.

63. The system according to claim 62, wherein the vinyl layer comprises a polyvinyl chloride film.

64. The system according to claim 62, wherein the camouflage pattern printed on the vinyl layer comprises a digital image printed on the vinyl layer with a digital printer using digital printing inks.

65. The system according to claim 62, wherein the laminate comprises a non-gloss film.

66. The system according to claim 62, wherein the laminate comprises a low gloss film.

67. The system according to claim 62, wherein the laminate includes ultraviolet protection.

68. The system according to claim 62, wherein the laminate is optically clear.

69. The system according to claim 62, wherein the laminate comprises a thickness of between about 0.5 mm to about 10 mm.

70. The system according to claim 62, wherein the laminate comprises a thickness of about 1.5 mm

71. The system according to claim 62, wherein the adhesive layer comprises a pressure sensitive adhesive.

72. The system according to claim 71, wherein the adhesive layer comprises a peel adhesion of about 3.2- about 4.6 pounds per inch.

73. The system according to claim 62, wherein the at least one vinyl adhesive layer further comprises a release liner covering the adhesive layer to protect the adhesive layer until time for application.

74. The method according to claim 62, wherein the at least one vinyl adhesive layer comprises panels that overlap at border sections.

75. The method according to claim 74, further comprising heating the panels at the overlapped border sections with an open flame.

76. The method according to claim 74, wherein the overlap of the panels is between about 0.75 inches and about 3 feet.

77. The method according to claim 76, wherein the overlap of the panels is between about 1.25 inches and about 4.0 inches.

78. The system according to claim 74, wherein the at least one vinyl adhesive layer includes a peel tab for each panel section configured to be the apparatus and demarcate the location to begin the peeling of the second vinyl adhesive layer from the first vinyl adhesive layer.

79. The system according to claim 78, wherein the peel tab comprises a discrete folded corner of the outermost border section of the respective at least one vinyl adhesive layer.
